(19) United States
(12) Patent Application Publication
(10) Pub. No.: US 2007/0214126 A1
(43) Pub. Date: Sep. 13, 2007

(54) Enhanced System and Method for Search

(75) Inventor: Dan KIKINIS, Saratoga, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: OTOPY, INC., Los Altos, CA (US)

(21) Appl. No.: 11/751,600

(22) Filed: May 21, 2007

Related U.S. Application Data
(63) Continuation-in-part of application No. 11/035,280, filed on Jan. 12, 2005.
(63) Continuation-in-part of application No. 11/197,482, filed on Aug. 3, 2005.
(60) Provisional application No. 60/536,142, filed on Jan. 12, 2004.
(60) Provisional application No. 60/598,864, filed on Aug. 3, 2004.
(60) Provisional application No. 60/669,168, filed on Apr. 6, 2005.
(60) Provisional application No. 60/802,890, filed on May 22, 2006.
(60) Provisional application No. 60/838,492, filed on Aug. 16, 2006.

(51) Int. Cl. G06F 17/30

(52) U.S. Cl. 707/3

(57) ABSTRACT

A method and system to enhance searching are provided. In one embodiment, the method, which can be embodied as a system, comprises receiving a search request, the search request comprising of one or more search terms limited to one or more selected dimensions of a multi-dimensional term relationship database (MDTRD); using the one or more search terms to search the database within the one or more selected dimensions of the database, to identify one or more additional search terms related to the search terms of the search request; and performing at least one of, presenting the additional search terms to be selected from to perform the search request, or performing the search requests using one or more of the additional search and presenting the results of the search request.

### CROSS-REFERENCE TO RELATED APPLICATIONS

The present application is a continuation-in-part of U.S. patent application Ser. No. 11/035,280, filed Jan. 12, 2005, which claims the benefit of U.S. Provisional Patent Application No. 60/536,142, filed Jan. 12, 2004; and U.S. patent application Ser. No. 11/197,482, filed Aug. 3, 2005, which claims the benefit of U.S. Provisional Patent Application No. 60/598,864, filed Aug. 3, 2004, and U.S. Provisional Patent Application No. 60/669,168, filed Apr. 6, 2005. In addition, the present application claims the benefit of U.S. Provisional Patent Application No. 60/802,890, filed May 22, 2006 and U.S. Provisional Patent Application No. 60/838,492 filed Aug. 16, 2006. The disclosures of the above-referenced applications are incorporated herein by reference.

### BACKGROUND OF THE INVENTION

In the pre-search field of search for information on the Internet, particularly on the World Wide Web, not many systems are currently available for users of the Web. Some meta-search engines are available that send an input to several engines and then try to cluster the results from all search engines and present them as one page of clustered results. However, the problem with this approach is that it requires a lot of reading and drilling down the results in clusters, and ultimately the results cover only topics that have been input in the key words. If an item is listed under a different key word, it is not found.

By offering alternative search terms to the user, the search is not only extended to different engines, but also searches using different terms that may yield better results than using the standard approach of key words for the search engines. What is clearly needed is an enhancement to the systems and methods that allows quick selection of alternative search terms and/or different search engines with a minimum time and effort. What is further needed is an enhancement of the methods and system for finding related term.

What is further needed is a method to not just provide different views of the dimensions of the vectors, but also to provide dynamic filtering for different sets of dimensions, allowing a more refined and targeted search, in the vast wasteland of Internet information today. Also further needed is a method to specifically enhance the targeted area with additional up-to-the-minute information that is being published and in some cases being made available for republishing through data feed technologies such as RSS (see http://en.wikipedia.org/wiki/RSS_(protocol)), Atom (see http://www.atomenabled.org), etc. that do not require external or third-party metadata in the process.

Often, it may be very difficult to find an item on the Internet, particularly on the World Wide Web, when a great number of words are involved in the search. The greater the number of words in a search string, the longer it takes to do a search, because the indexing algorithms used for searching require re-indexing for newly added content, thus becoming very cumbersome when there are a great many words in a search term.

What is clearly needed is a system and method for searching long and complex search strings without having to re-index, thus greatly speeding up the search process.

### SUMMARY

In one embodiment, a method and system to enhance searching are provided. In one embodiment, the method, which can be embodied as a system, comprises receiving a search request, the search request comprising of one or more search terms limited to one or more selected dimensions of a multi-dimensional term relationship database (MDTRD); using the one or more search terms to search the database within the one or more selected dimensions of the database, to identify one or more additional search terms related to the search terms of the search request; and performing at least one of, presenting the additional search terms to be selected from to perform the search request, or performing the search requests using one or more of the additional search and presenting the results of the search request.

### BRIEF DESCRIPTION OF THE FIGURES

FIG. 1 shows an overview of a search system in accordance with one embodiment.

FIG. 2 shows in more detail how software instance interacts with the system in accordance with one embodiment.

FIG. 3 shows a screen as it could appear, according to the preferred embodiment of the novel art of this disclosure in accordance with one embodiment.

FIG. 3B shows an example of a “cookie crumb” bar in accordance with one embodiment.

FIG. 4 shows a blow-up of the basic two-ring hexagonal structure for normal users in accordance with one embodiment.

FIG. 4A shows an example of the results in window of a consultation with a dictionary server such as server in accordance with one embodiment.

FIG. 5 shows the unpopulated cells are grayed out, while the populated cells are filled out in various colors in accordance with one embodiment.

FIGS. 6A & 6B provide an overview diagram of an example system of one embodiment.

FIG. 7 is an architectural block diagram of search assistant system 700 of one embodiment.

FIG. 8 shows an example of a process that may occur when a prospective ad buyer is interested in selling a product.

FIG. 9 shows a system for using a relational database to organize terms and term relationships, according to one embodiment.

FIG. 10 provides a block diagram describing processes in accordance with one embodiment.

FIG. 11 provides a flow diagram describing processes in accordance with one embodiment.

FIGS. 12A-D provide a flow diagram describing processes in accordance with one embodiment.

FIGS. 13A-D provide a flow diagram describing processes in accordance with one embodiment.

FIG. 14 shows a simplified overview of an exemplary embodiment of the real-time content association system, in accordance with one embodiment.

FIG. 15 shows an exemplary process flow 1500 of generating web site lists, in accordance with one embodiment.

FIG. 16 shows a simplified process flow 1600 of the operation of RSS and Atom spider, in accordance with one embodiment.

FIG. 17 shows an exemplary process flow 1700 of the operation of server applet, in accordance with one embodiment.

FIG. 18 shows a simple overview of a TRDB server system, in accordance with one embodiment.

FIG. 19 shows a schematic overview of an aspect 1900 of the functional use of the vectors within term relationship database, in accordance with one embodiment.

FIG. 20 shows an exemplary use of the type dimension shown as a set-theory view, in accordance with one embodiment.

FIG. 21 shows more detail about using multiple local and remote database, in accordance with one embodiment.

FIG. 22 shows an enhanced overview 2200 of the software system for term (n-gram) and term relationship extraction/generation, in accordance with one embodiment.

FIG. 23 shows an exemplary set of details 2300 of table 2202, in accordance with one embodiment.

FIG. 24 shows the data set 2201, in accordance with one embodiment.

FIG. 25 shows an exemplary process 2500 for implementation of the system according to one embodiment of the present invention, in accordance with one embodiment.

FIG. 26 shows the approach 2600 of the current invention for a search, in accordance with one embodiment.

### DETAILED DESCRIPTION OF THE INVENTION

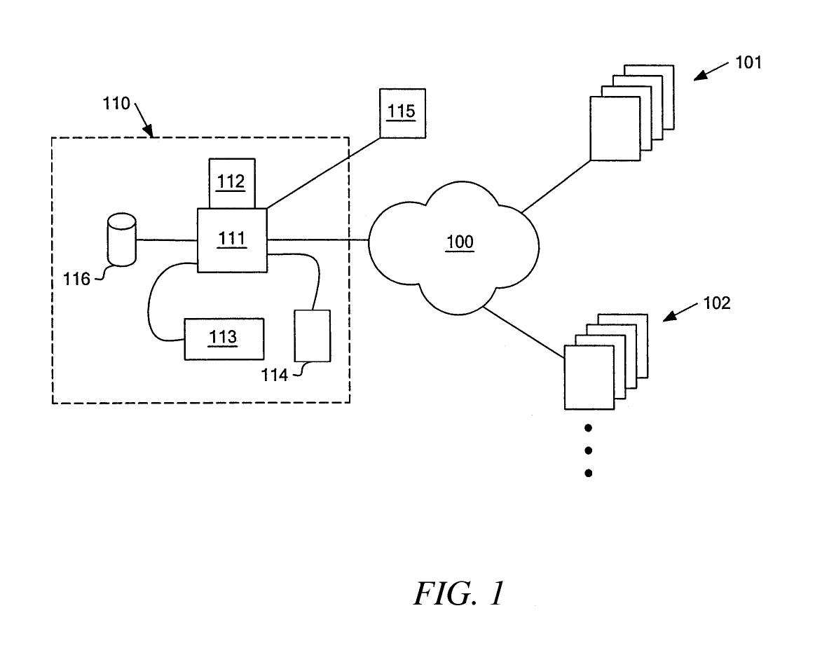

FIG. 1 shows an overview of a search system. Internet 100 is connected to several search services/engines, including, as shown in FIG. 1, search service 101 and search service 102, each of which has billions of information items. Connected to the Internet is a client device 111 in a user's office or home location 110. Elements of the client device 111 may include, but are not limited to, a monitor 112, a local storage 116, a pointing device 114 (such as a mouse, trackball, or other similar device), a television, a phone (cellular or other), a mobile navigation device (such as those found in automobiles, planes, boats, etc,) and an input device 113 such as, but not limited to, a keyboard, a mouse, or any other useful pointing device, including such as used on so-called “tablet PCs” or equivalent devices, also including gloves or even voice recognition software, etc. Also shown is a software instance 115 of the novel art of this disclosure.

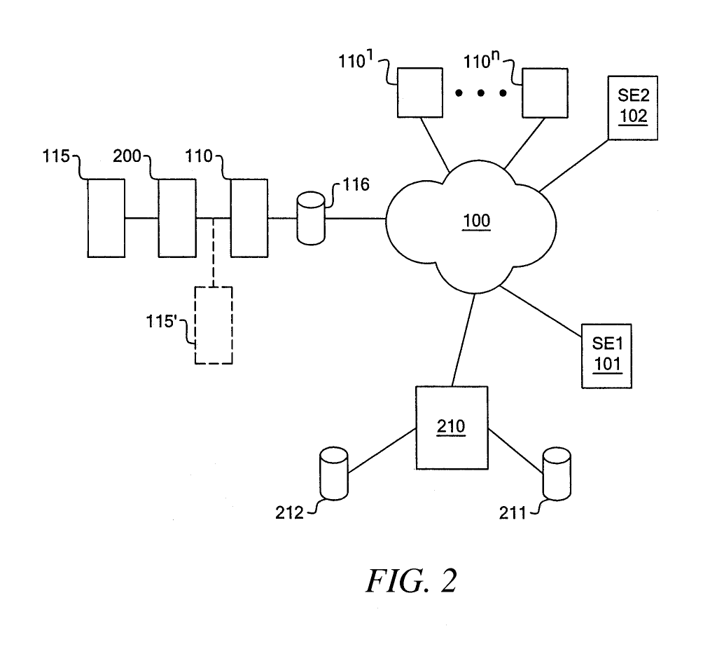

FIG. 2 shows in more detail how software instance 115 interacts with the system. Client device 111 contains a web browser 200. Software instance 115 may be plugged into or executed completely within the browser 200 as is shown in FIG. 1, or in some cases it may be similar to a hidden proxy 115′ behind the browser. Any combination or variation of these two scenarios may be possible without departing from the spirit of the novel art of this disclosure. Also shown again is Internet 100. It is clear that any of many variations of connection between device 111 and Internet 100 may be used, including but not limited to wireless, wired, satellite, or infrared links. Furthermore, it does not matter whether client device 111 is a personal computer or workstation, a mobile device such as a cell phone or pocket PC. Local storage 116 may be a hard disk or some other form of nonvolatile memory, such as a SmartCard, optical disk, etc.

In addition to search engines SE1 101 and SE2 102, also shown is server system 210, which allows the user to download the application 115 or 115′. System 210 has two storage areas 211 and 212.

Storage area 211 contains applications for download to various devices and also dictionaries and thesauri with semantic synonym relationship tables, allowing application 115 or 115′ to look up broader, narrower, related, or synonym terms, as described in greater detail below. There may be a variety of downloads available, such as for web phones or other portable devices, or Apple computers and other non-Windows operating systems, such as Linux, Unix, etc.

Storage 212 may be used to store a user's personal information. Personal information would include, but not be limited to, a person's search criteria, history or favorite search terms, recent searches, industry or category-specific data (tied to special area of interest searches), stored navigation paths within the thesaurus data, personal additions to the thesaurus, etc. Depending on the system, in some cases personal information may be stored on local storage 116, while in other cases an account may be established permitting information to be stored on server storage 212. In some cases, an enterprise server (not shown) may provide proprietary storage inside the boundaries of an intranet for employees and contractors of an enterprise, for example, or government agencies, etc. The advantages of storing information on a server may be that if the user searches from a variety of different client devices 111, the user can always have his personal information available. Server 210 as shown in this embodiment may in some cases be a public service operated by a provider, while in other cases it may be an enterprise-wide server behind an enterprise firewall on a virtual private network. Also, search engines 101 and 102 may in some cases be public sites, for example, while in other cases they may be private network search engines on an enterprise intranet, or subscription search engines such as legal, medical, or other specialized areas.

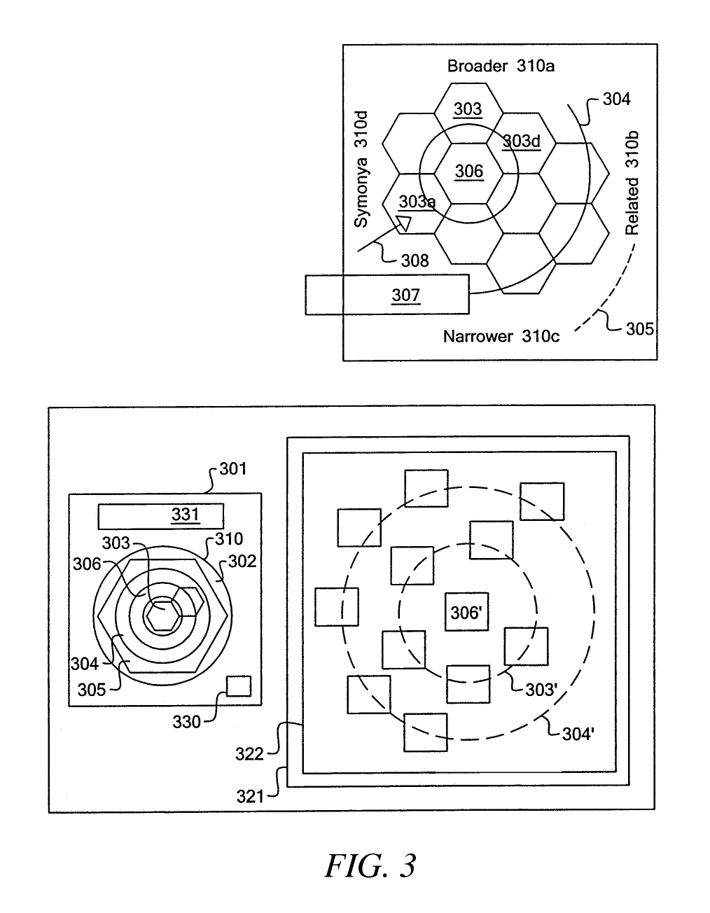

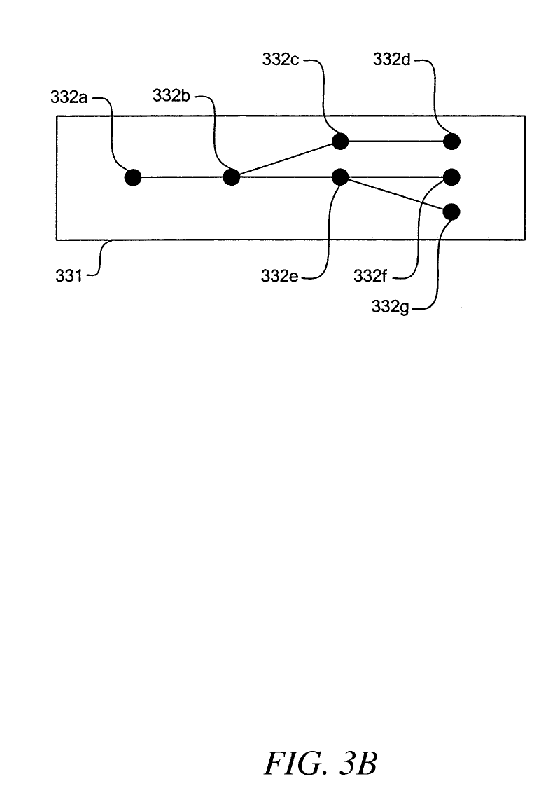

FIG. 3 shows a screen as it could appear, according to one embodiment of the novel art of this disclosure. Two major components are shown: navigation control window 301 and information display (search result) window 321.

Window 301 contains several novel elements. One element is a polygon-shaped form 302, with a hexagonal-shaped embodiment shown here, containing a variety of cells. The cells could be in the form of a circle or could have any combination of sides, numbering three or larger. Some of these cells may be colored. At the center of the hexagonal array 302 is cell 306, where the initial search term is entered. At the top of the window is a “cookie crumb” bar 331, which allows the user to navigate among multiple paths of current searches. This feature is discussed in greater detail below.

The user may enter a search term in center cell 306 or in a text box that appears above, in front of, or instead of form 302 at the initial entry into the system. Application 115 or 115′ then consults server 210 and its associated dictionary 211, and the results are then populated into the cells of the polygon structure 302, as described in greater detail in the discussion below. It is clear that the server for the dictionary search need not be the same server on which the user information is stored, and in fact, it may be at a different location. Further, in some instances, for example in an enterprise environment, an additional local, private dictionary server may be used in addition to or instead of the dictionary server shown in FIG. 3.

Also available is a button 330 that allows the user to send the entire search to another party. If the destination party does not have software instance 115 installed, the send function offers a link to download software instance 115 and store it and then make the search available.

Each cell offers the opportunity to zoom in for a more detailed slice of the resulting data. This capability can be expanded and would be extremely useful to researchers and others. There can be further rings (i.e., 305, etc.), and large displays would easily support five or ten rings, or even more. Also, partial transparent multiple planes of the honeycomb could be in 3-D and thus open up more and deeper opportunities for displaying results. They could, for example, be assigned to different search engines, archives etc.

As the user moves from ring to ring or from side to side or plane to plane he may be presented with a password for security purposes. For example, in the Mustang example described below, a user could hit a Ford Zone requiring a password to get in. And then within that area the original BOM may be presented, which could require yet another password. Further, payment may be required, which could be managed by either having a subscription to a for-fee database, or allowing a micropayment mechanism (not shown) to reside in software instance 115. Such systems would make allowances for the fluidity of databases (both public and private, free and for fee) over time. Passwords may be prompted for in the usual manner, or may be stored in either a common password vault, such as Microsoft™ Passport™, or in a proprietary system (not shown) integrated in software instance 115, and stored along with other personal data as described above.

Also, importantly, multi-lingual support may be added, offering multiple language dictionaries, thesauri and other tools (i.e., spell checking), allowing performance of multilingual searches.

In yet other aspects, spell checking may be offered at the entry window, either single language, or multi lingual. Further, tracking mechanisms may be included, both on personal and system levels, allowing the software to track the success of searches and dynamic refinement of both personal and public dictionaries and thesauri. Public statistics may also be used to optimize sponsorship of ads, which may be added in some instances, for example, to the basic free service. Lastly, tracking may also be used for billing purposes in case of “buyers lead” agreements, where searches result in commercial activity, either directly with a merchant, or by a sharing agreement in the commission paid to the underlying search engine used.

One embodiment includes the colors, textures, font changes, 3-D hints, and the unconscious (subliminal) queues used to navigate visually through the semantic map of the clusters of documents derived from the data collections (search engines and databases). Also, sound or background music may be added to add to the subliminal effects of intuitively enhanced search.

Around center element 306, cells that contain terms are arranged in rings. Terms in rings close to the center are closer in semantic meaning to the center element term 306. Terms in rings farther away from the center term are further away in semantic meaning from the central search term. There may be different numbers of rings, depending on the type of search and individual searching. For example, a professional searcher or experienced individual may enable the display of five or six rings, expanding the visual cache and breadth of search coverage (recall), while for public, generalized, precision-oriented searches, there may be only one or two rings.

Also, not all polygons may be filled. Those that are not filled may be grayed out (unavailable), while those that are filled may be colored to indicate semantic relationships among the terms. The color saturation of cells indicates the density (number and size of document clusters) with close semantic meaning to the search term. The color mixture of the cells indicates the semantic relationship of the term within the central white cell to the term within the colored cell. Green corresponds to broader terms; blue is for synonyms; red is for narrower terms. Cell colors of the terms are a mixture based on the relative strength of the thesaurus relationships to the white central term. For example, the amount of “synonymity” (sameness) between the central term and a given term determines the amount of blue in its color. The term's specificity to distinguish among document clusters (narrowness) determines the amount of red in its color. Therefore a purple term is both narrower and synonymous and the exact color mixture is based on the combination and strength of these attributes. Because of the small number of different thesaurus relationships and large number of different color possibilities, the user of this system quickly and subliminally grasps the relationship or association between the term in a colored cell and the central term. The darkness of the font of the term reflects the confidence in the term's placement and its specificity to the current relationship. Frequent, non-specific terms that may veer off into other clusters of the collection semantically unrelated are thinner; more specific and discriminating terms are bolder.

The relationship ring 310 outside search rings 303 and 304 contains words describing the semantic relationships of the resulting terms to the original term. In the exploded detail included in FIG. 3, the words describing relationships of the elements are, for example, Broader 310a (top), Narrower 310c (bottom), Synonym 310d, and Related Terms 310b.

Because the terms themselves are derived from document clusters, the system exposes language (search terms) and therefore also areas of the search engine or database that the user would not ordinarily uncover. The coloring, including mixture, hue, and saturation of these terms, enables a subliminal, intuitive navigation to new and expanded search terms that in turn enable finding the desired results in the underlying search engine or database.

It is possible to map these term relationships to sounds in addition to or instead of colors. For a blind person or for telephone retrieval (including cell phones), as well as tv program guides, the sound and tone of a background music added or of the voice speaking each search term can correspond to the term's relationship to the central term. And, since there are so few relationships, the telephone keypad could be mapped to the corresponding navigation paths—2 could correspond to broader; 4 corresponds to synonyms; 6 is for related terms; 8 is for narrower. The other numbers are similarly a mixture of the types of relationship. So 1 would be both broader and synonymous; 3 would be both broader and related; 7 could be both narrower and synonymous, and 9 is both related and narrower. Color saturation, hue, and exact color mixture would correspond to corresponding aspects of the voice reading the term.

The term relationships are derived from clusters of documents within the back-end search systems, not from a “pure” linguistic definition of the words and phrases composing the search terms. The search terms may appear to have widely varying linguistic meaning in a pure natural language sense; semantic document similarities of groups of documents that are similar to the top matches of the original search terms are used to derive terms that discriminate a different group of documents. The terms displayed in the surrounding rings discriminate these new groups (clusters) of documents, which would otherwise not be included as the result of searches from the original vocabulary of the search terms or as related to the documents the original terms retrieve.

These clusters can be automatically derived.

The hexagon structure 302 has white cells in the center and highly saturated color in the farthest cells. The colors are arranged in a color circle. Depending on the search result, the colors may be compressed or expanded to represent the narrower or wider availability of related terms.

As the user moves a cursor 308 over a cell, for example cell 303a, a popup 307 appears that displays a large, easily readable display of the search term in cell 303a, at least two hexes away, so that the user can always navigate out of the selected hex. By clicking on a cell, the user can choose to move the term within the cell into the center position 306 and restart the whole range of searches. For each cell that contains a term a search is commissioned on a search engine and the results are displayed in overlay 322. These overlays may use different levels of transparency, allowing the underlying thumbnails to appear almost like watermarks. Special zoom in-out effects may be used to make the appearance visually more pleasant, as well as enhanced by some sound effects The results are represented by little thumbnail windows, such as, for example, thumbnail 306′ representing the search for the term in center 306, with ring 303′ containing up to six thumbnail windows and likewise ring 304′ containing corresponding thumbnails, etc.

As the cursor moves over a term, as shown in the expanded detail, not only does popup 307 appear, but also an overlay 322 overlaying the thumbnails with an 80 percent screen, so the thumbnails appear only as slight shadows, and window 322 shows the unmodified search results as delivered from the search engine(s).

In some cases, multiple engines may be used in one search; while in other cases, multiple hexagonal structures 302 may exist in different planes that may be navigated using a scroll bar on the right side of the window (not shown). By navigating among various hexagonal structures 302, different windows 322 would appear that contain the results of different search engines. For example, in a professional search environment in an enterprise, the first two layers may be two different intranet search engines. The other layers may then represent public search engines, or specialized search engines, such as for example, the United States Patent and Trademark Office search engine.

FIG. 3B shows an example of a “cookie crumb” bar 331. In this example, the initial crumb (node) 332a led to another crumb 332b, which then branched out to crumbs 332c and 332d. The user was not happy with the results, and clicked on crumb 332b, starting a new branch in a different direction to crumb 332e. As he went on to crumb 332f, he didn't like the results. He then went back to crumb 332e and sidetracked to crumb 332g. The difference between the historical or back and forward navigation offered in browsers known in current art and the novel art of this disclosure is that with bar 331, the user can quickly move from one search branch to another; whereas in current art, once you go back and start in a new direction, the old direction is no longer available in your branch and is much more difficult to find in the history. Again, as an option in bar 331, each of the crumbs, when moved over with a cursor, may open a bubble showing the search term associated with that particular crumb. And moving the cursor over that term causes the associated window with results to change, reflecting the results of queries to the search engine(s). Other techniques may be used instead of cookie crumbs, such as drop down menu-lists, etc., as long as they allow a multi-linear history retrace.

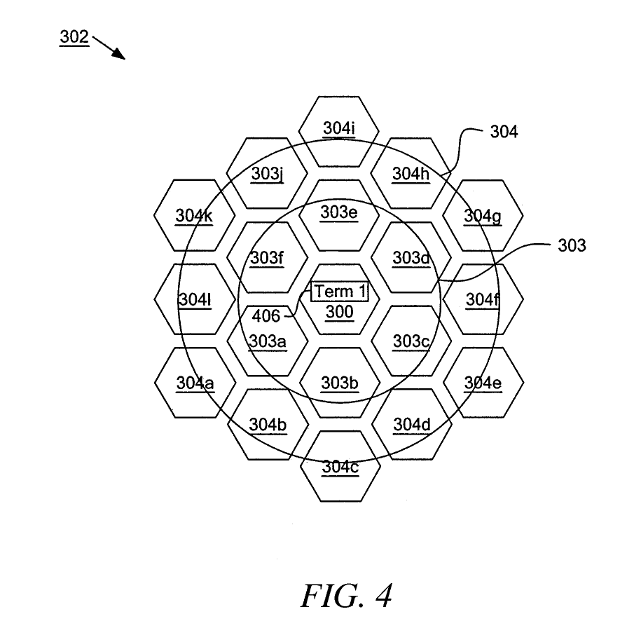

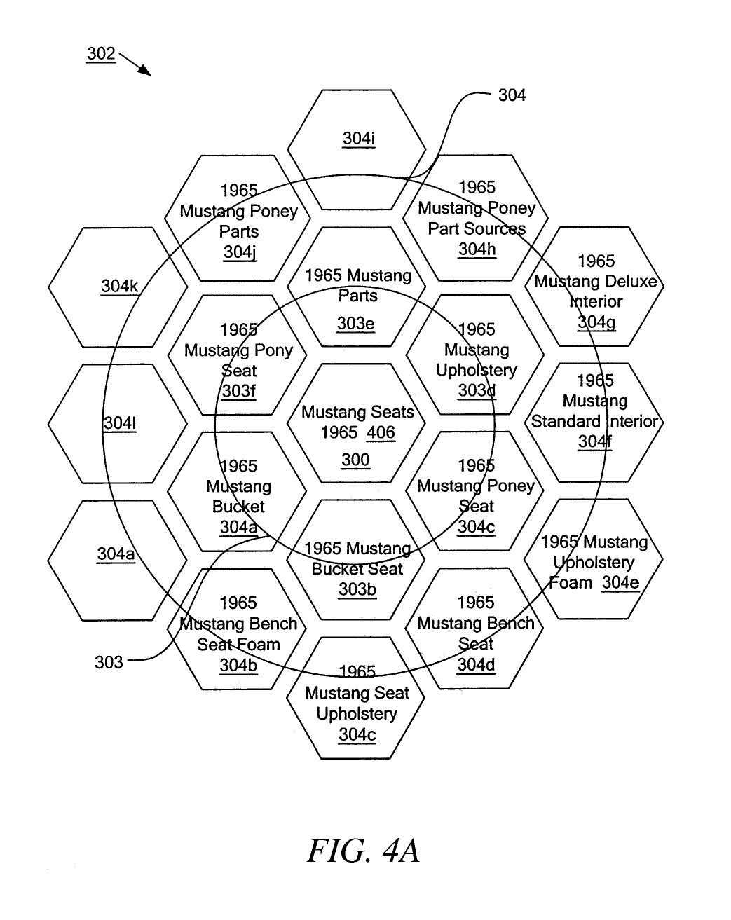

FIG. 4 shows a blow-up of the basic two-ring hexagonal structure for normal users. At the center is cell 306, showing the original search term, then related terms are shown around it. The farther away the rings are from the center, the more saturated their color becomes.

FIG. 4A shows an example of the results in window 301 of a consultation with a dictionary server such as server 210.

In this example history, 17-year-old Jimmy has a restored 1965 Ford Mustang in need of new seats. Jimmy and his father go to a search engine search site on the Internet and type in “1965 mustang seats,” but they find no seats for sale. They try queries such as “1965 mustang seats for sale,” “1965 ford mustang seats,” “1965 mustang horse emblem seat” but cannot find what they want—the pony deluxe seats that have the horse emblem on them. But then the father opens an email message from his brother with a link to the search assistant software instance 115. He clicks on the link, downloads, and then starts the application.

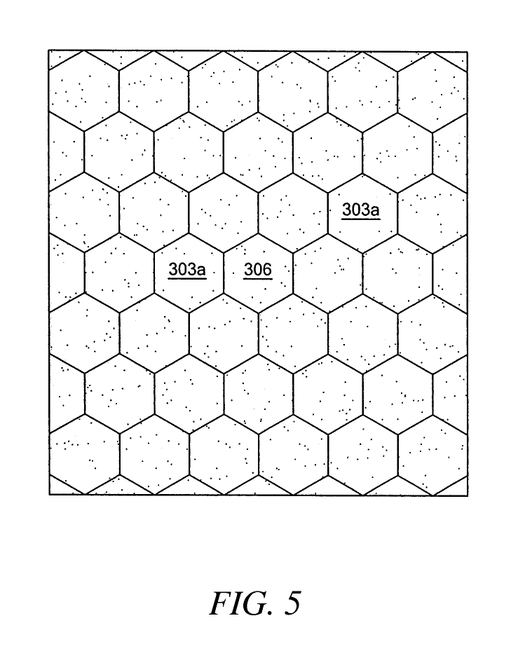

He enters search term 406, which is “1965 Mustang seats,” and as shown in FIG. 4A, various cells around the center are populated, although not all cells. The unpopulated cells are grayed out, while the populated cells are filled out in various colors, as shown in the color pattern in FIG. 5. FIG. 5 shows more than two rings, but the embodiment shown in FIG. 5 is a variation that is within the spirit and scope of the novel art of this disclosure.

In FIG. 4A, to the left are synonyms such as 1965 mustang pony seat, 1965 mustang bucket.

To the right are related terms, including 1965 mustang upholstery, 1965 mustang pony seat, 1965 mustang deluxe interior, 1965 mustang standard interior, and 1965 mustang upholstery.

Below are narrower terms, such as 1965 mustang bucket seat, 1965 mustang bench seat, 1965 mustang seat foam, and 1965 mustang seat upholstery.

Above are broader terms, including 1965 mustang parts, 1965 mustang pony parts, and 1965 mustang pony part sources.

At the same time as the control window 301 morphs from text entry to the color hex map, window 321 opens with thumbnails of results pages. The thumbnails are arranged and colored to correspond to their respective terms in window 301. Inside each is a very small results page, truncated to the top five results. At the top of the second window is the result for “1965 mustang seat” with white background, again truncated to five results.

Jimmy's dad navigates from the center, to the right, clicking on “1965 mustang pony seat”. He clicks on the first and fourth results, which provide a selection to purchase the seats.

Other geometric shapes may be used instead of hexagons, such as squares, octagons, triangles etc. providing for more directionality. Also, gray shades or texture may be used instead or additionally to color. Sound may be used to enhance the subliminal effect, by changing the tune according to the area the cursor hovers above etc.

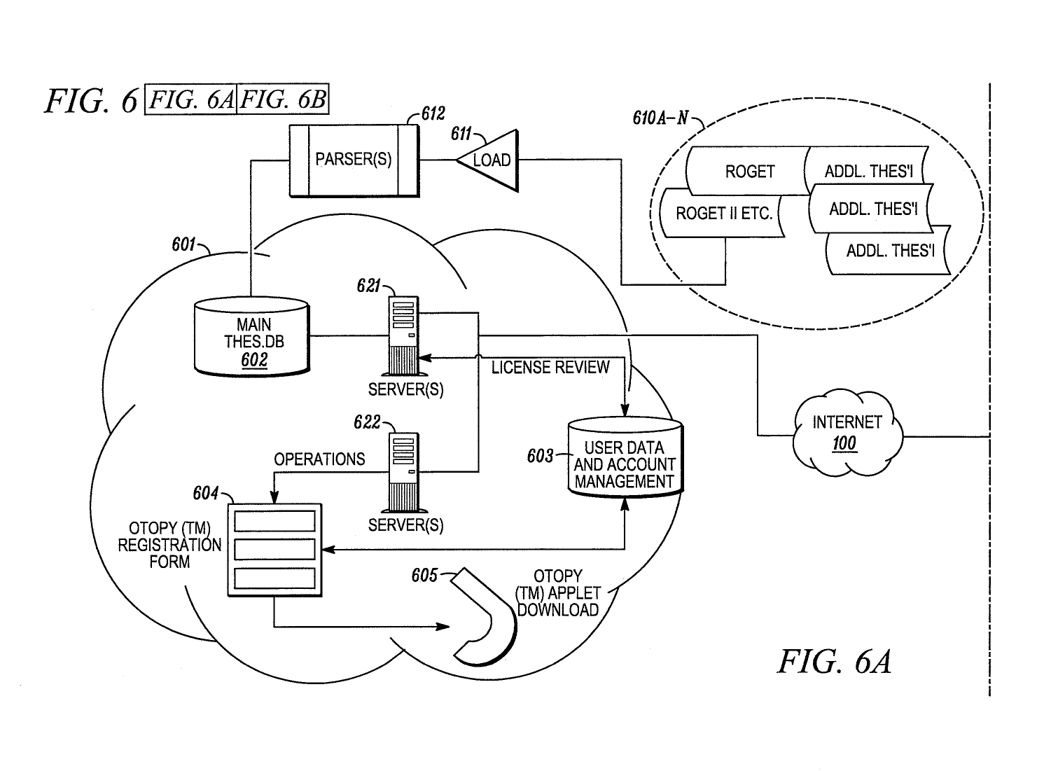

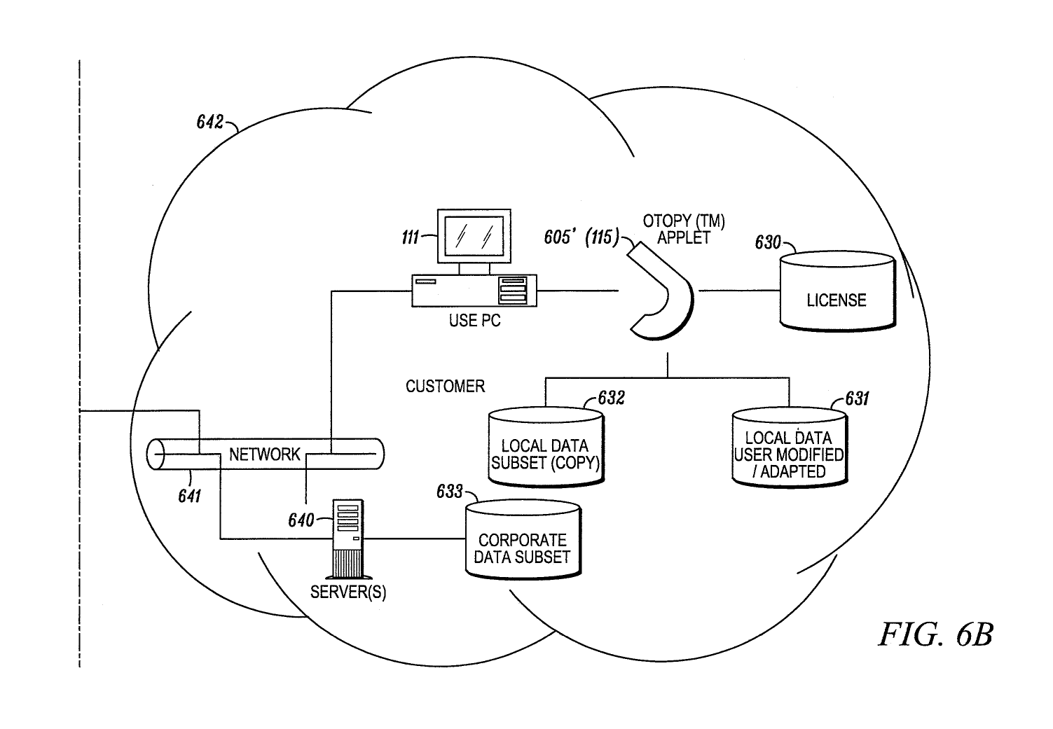

FIGS. 6 A & B provide an overview diagram of an example system of one embodiment. Customer site 642 may be any customer site, but in this example it is the site of a large corporation. Site 642 connects via Internet cloud 100 to operation center 601. Multiple thesauri 610 a-n may be read through loader 611 and parser 612 into main database 602, where the thesauri are stored as a set of memory objects. This approach allows optimization of communications between client and server and only transmit a region of a search query. Thus for any given search term, only the related region of the memory object is transmitted from the server to the client (along with additional information, such as ads). Hitherto, thesauri in a flat file format (meaning a simple text file) had a size of about 5 to 10 megabytes. As a parsed memory object, the same thesauri would now be in the range of about 1 to 2 megabytes, and the area required for the search (the related terms, as explained earlier, i.e., related, broad or narrow, and synonymous) may be in the range of 10 to 20 kilobytes.

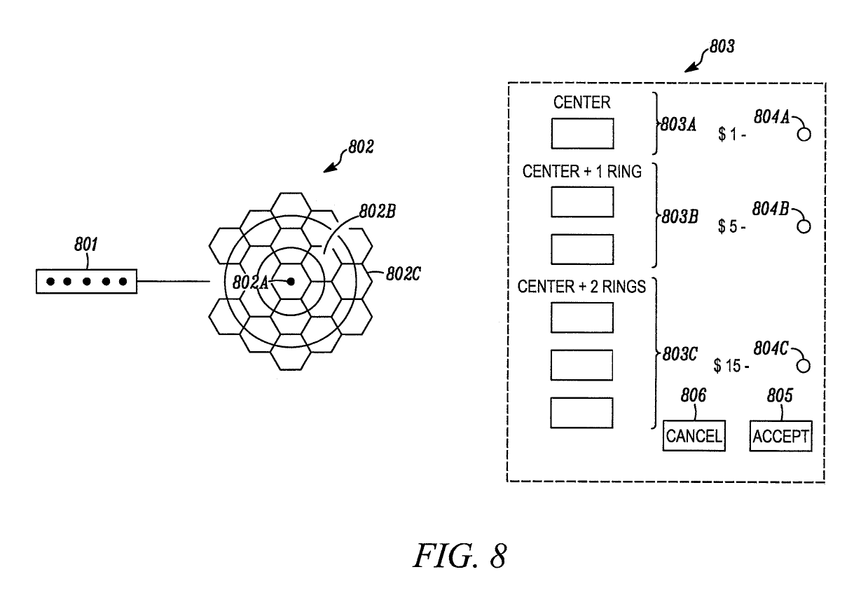

Also, in some cases, additional advertisements may be offered, tied to those search terms. These advertisements may also be stored also in main thesaurus database 602. Addition of these advertisements is not shown, but it is clear that commonly used, well known e-commerce techniques such as self service ad sales, etc., may be used to permit advertisers to add advertisements and tie their terms to terms in the main thesauri. Such an approach would result in extremely targeted advertising. FIG. 8 shows an example of a process that may occur when a prospective ad buyer is interested in selling a product. The program may offer to let the prospective ad buyer enter a term in interface 801, said term being one whose entry by a person using the search function would trigger appearance of an ad. The program could then offer a selection of sets 802a, 802b, and 802c, for example, of the term, using an interface 802 that is essentially similar to the interface presented for searching. The prospective ad buyer then may decide to buy only the center term 802a, or the center term 802a and a first ring terms 802b, the center term 802a, a first ring terms 802b, and second ring terms 802c, etc. Then a price 804a, 804b, or 804c, for example, would be shown next to each option, and the prospective ad buyer could choose the option, knowing the price, by clicking acceptance button 805, or the prospective ad buyer could cancel the transaction by clicking cancel button 806. Finally, pay would be settled, by either allowing use of the buyer's credit card, or charging to an established user account that has approved credit. Although the payment process is not shown here, both the above-mentioned payment methods are well-known in current art.

In FIG. 6 A, server 621 is responsible for delivering required sections of the thesauri, with or without advertisements, to client machine 111. It is clear that element 621 may be not a single server, but may rather be a complex multiserver, multisite system that delivers the content to the user from a nearby operating server, rather than from a single server for worldwide operations. All these modifications that can be done and often are done to improve performance and save costs shall not be considered different in terms of operation and functionality within the scope of the novel art of this disclosure.

Also present in the operation center is account management and license server 622. Server 622 maintains the user data and account management database 603, which records the user data in cases where certain thesauri are only available to certain customers, or certain services are only available to premium customers. Again, server 622 could be a multitude of servers, as discussed above in the case of server 621. It could also manage, for example, a registration form 604 that a user may have to fill out before being able to download application 605, shown here as a java applet.

After downloading, application 605 then runs on client machine 111 as application 605′, earlier described as application 115, but not exactly in the same capacity. Typically such an application would be a java script or java applet that would be cached in the browser locally, and hence would persist. It may include a set of databases, such as license database 630 that manages the license; local user database 631, which stores click-throughs that the user has done. These click-throughs then may be communicated from time to time to the main database 602 to improve links in the main thesauri. Application 605 may also include local user subset 632, where sections that the user often uses from main database 602 may be cached locally. Further, in case the user is an enterprise user, his network 641 may have an intranet subserver 640, which can run a local database 633 for in-house application. This database 633 could be used in manner similar to that of the usage of a knowledge base for in-house purposes.

In some cases, the intranet of the corporation, which obviously can extend over several physical locations, would be parsed, and a specific thesaurus could be created to reflect the types of documents available on that intranet. That specific thesaurus (not shown) would then be stored in database 633, allowing intranet users to have access to the corporation's knowledge base. Again, additionally (not shown) some license server may be attached to that database 633 to allow external customers of the corporation, for example, to do certain defined, limited searches on the corporate knowledge base. As another example of such an in-house knowledge base In other settings, a university could allow certain affiliated companies and/or institutes to share some of the data but not necessarily all of it.

It is clear that many variations in detail can be made. For example, the knowledge database could be outsourced and be managed by an outside company, either or both for the operation center 601 and corporation site 642. Instead of java script, other similar equivalent language application models may be used, such as java beans, java, X-object, etc., without resulting in a different functionality. Each of these models may have their own advantages and/or disadvantages, and therefore may be more desirable in one case rather than another. The preferred model is to use java script necessitating cascading style sheets, because that model is universally support by almost every browser available today, but as technology will and does change, the preferred model may change also.

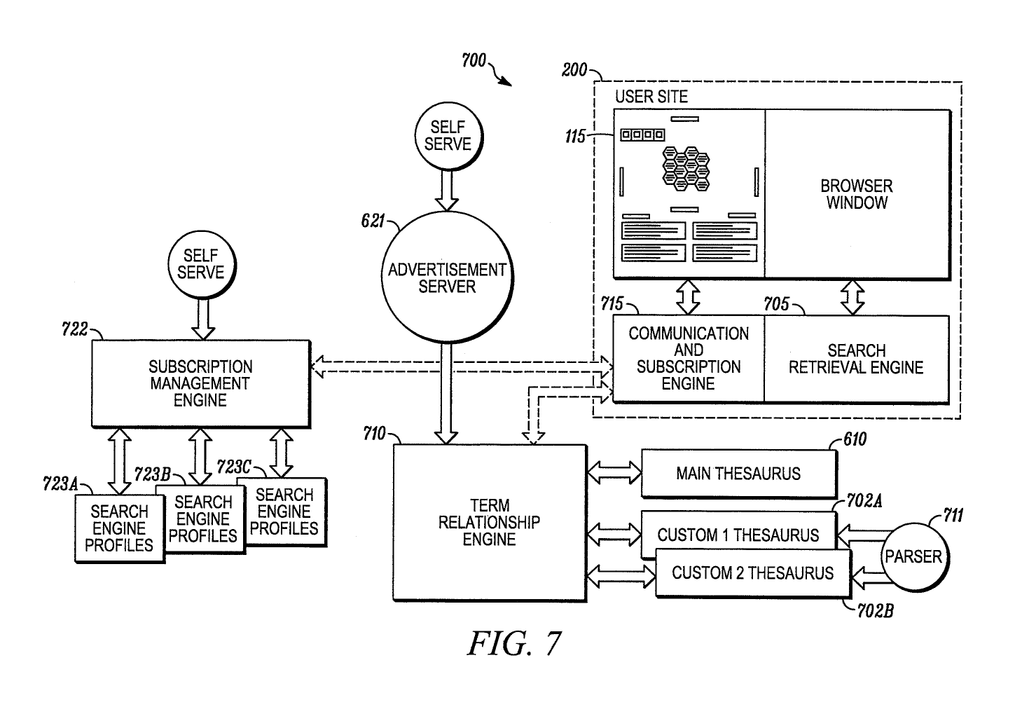

FIG. 7 is an architectural block diagram of search assistant system 700 of one embodiment. Part of software instance 115 runs as a bar or otherwise in browser window 200 (or its tool bar region) and is supported by communication and subscription engine 715 and search retrieval engine 705. The user interface of software instance 115 would provides visual cues to assist in navigating to most relevant search terms. A key component of such cues is color, with, for example, fonts, font sizes, textures, and sound also acting as cues. Results would be organized to show synonyms, related terms, and broader and narrower concepts, as described in the discussion of FIG. 1. Clearly, while shown here consistently as a hex paradigm interface, it must be looked at as a “skin” type interface (commonly used by video and music players allowing the user to change the look on access to options, choosing a “dumbed down” version, or a highly sophisticated version), and other types may be offered. For example in some cases, the user may change a skin matching his preferences, skills, etc., or in other cases, marketing partners may force a new skin on a user according to an agreement, etc. Other skins may be in the form of simple lists, a short list, a single circle, seven circles, squares instead of hexes, octagons, etc. The list type may still contain a small hex layout as a mini navigation help in a corner, or may not, etc. Also, different color schemes, branding, etc., may be offered.

Subscription management engine 722 exchanges data such as, for example, information about partnership affiliation, paid subscription for premium services that may be available, etc., with engine 715, thus allowing also control of a partnership branding, for example, branding with a primary search engine, etc. Term relationship engine 710 draws from main thesaurus 610 and custom thesauri 702a and 702b to expose search phrases that can discriminate among document categories within search engine results. Engine 710 is thus able to expose clusters of terms and categories of documents (based on term use) and derive broader term concepts (term relationship) from search results of parsing websites with parser 711. Further, to accelerate the ingestion of terms and term relationships, the top 20 percent of failed searches might be purchased and added as initial data manually to the thesaurus. The intelligent thesauri 610, 702a, and 702b would be initially based on a public domain thesaurus, for example Roget's Thesaurus or other suitable ones, but their knowledge bases (i.e., terms and term relationships) would grow with usage. Through self learning algorithms they could identify new connections among search terms and phrases and pull them closer over time, for example by tracing click-throughs of users.

This whole approach can be applied to proprietary or domain-specific knowledge bases, such as law libraries; pharmaceutical or regulatory information, etc. Also, proprietary knowledge bases may be parsed into thesauri, and then offered at the enterprise level for internal use (i.e., corporate database subset or thesaurus 633 as shown in FIG. 6B), but using the same tools. In addition, custom skins may be used for different fields. For example, medical researchers may use a body map to locate certain types of terms, etc., and field related symptoms, etc.

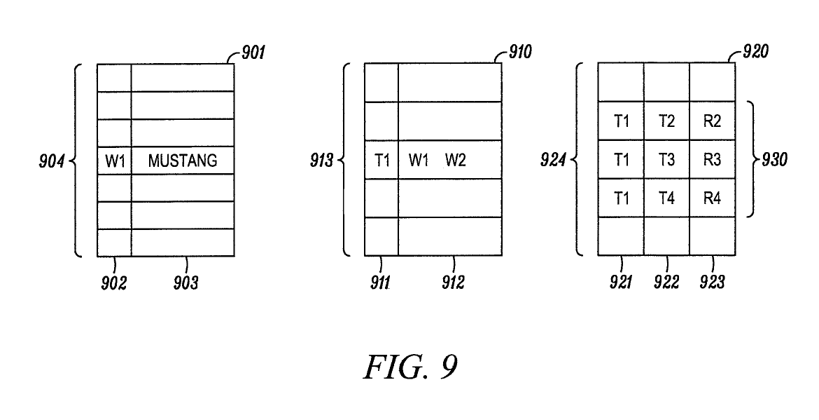

FIG. 9 shows a method and a system for using a relational database to organize terms and term relationships, according to one embodiment. Table 901 is used to tokenize words. Each word in column 903 has a corresponding token in column 902, such as, for example, token W1 for the word Mustang. The list 924 in table 901 may in some case be very long; it may also have multiple words from different languages, etc. Typically, the words would be stored in root forms, i.e., in basic, unconjugated, undeclinated forms. Then each word is used to form terms in a term table 910. For each term in column 911, such as T1, a group of words W1, W2, etc., in column 912 forms the term. The order of the words in column 912 is also important, because sometimes swapping words may change the meaning of the term. Then table 920 establishes the term relationships. In column 921 is the term T1 a user may be seeking, and in column 922 is a term T2, T3, or T4 that T1 is related to, and in column 923 is the relationship information, in this example R2, R3, R4, grading the relationship between term T1 and term T2 (R2), term T1 and term T3 (R3), and term T1 and term T4 (R4).

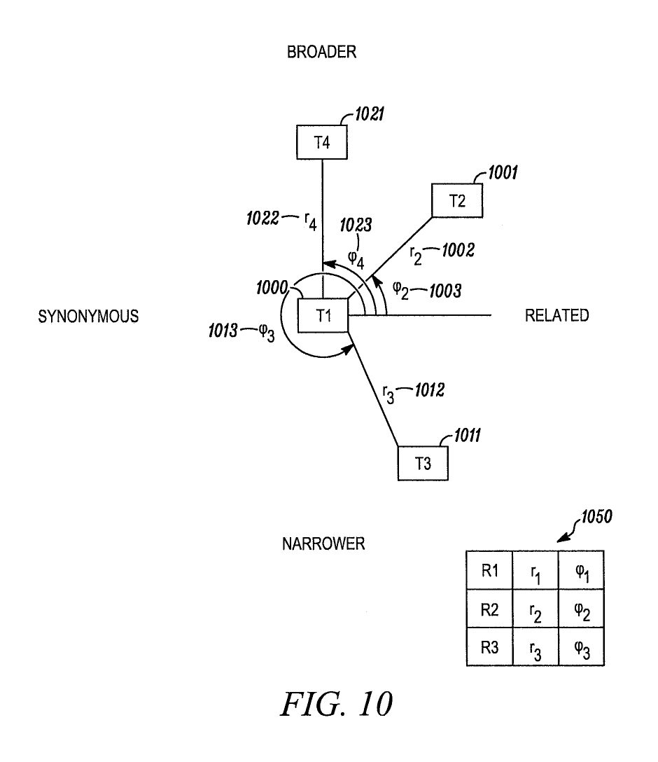

There are many methods by which term relationships may be expressed. One example method is shown in FIG. 10. In this example of a preferred embodiment, the original search term T1 1000 is at the center of the relationship space The related terms T2 1001, T3 1011, and T41021 are set in space around T1. The space shown here corresponds to the space of the navigation tool shown in FIG. 3; namely, with Broader and Narrower at the top and bottom, and Synonymous and Related to the left and right. However, in some cases the space may be described in different terms, for example, Synonymous and Related may be on one side, and Antonymous may be at the other side. Clearly, simpler terms may be used, such as “same” (for related or synonymous), “opposite” (for antonymous), “more general” for broader and “more specific” for narrower etc. The term relationship is expressed in this example as a polar coordinate for a two dimensional space, with a Phi vector 1003 or 1013 showing the direction or type of the relationship, and the r vector 1002 or 1012 showing the closeness or the distance of relationship. The closer the related term is to the original search term, the more relevant it is. Hence, for example, when click-throughs to a specific related term occur frequently, the corresponding radius might be shortened each time, or every time a set limit is reached, etc. In this example, the relationship between T1 1000 and T2 1001 could grow stronger based on novel use in a language, and hence the radius r2 1002 would be shortened with each use. It is clear, that in some cases, more than two dimensions may be used, and that Cartesian coordinates are interchangeable with polar coordinates, though polar coordinates are better for fast calculating distances in space.

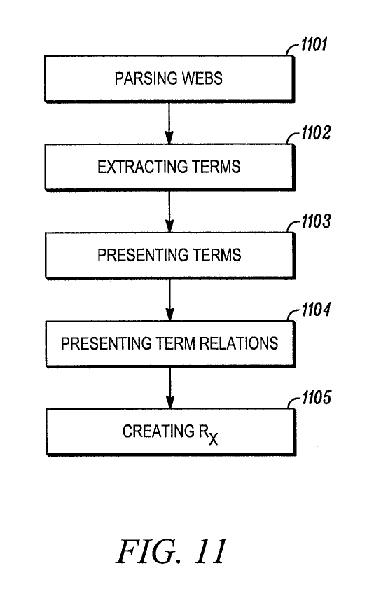

In such a method and system of expressing relationships between terms, a problem may arise when setting up the initial relationship map, because the system, as a result of too little information in the main database, may not necessarily be able to understand (respectively process) the relationship of two terms from just looking at them. FIG. 11 shows an approach that can be used to solve this problem. In process 1101, the Web is parsed on a regular basis. In particular, specific web sites that are trend-setting or informative are used, such as daily or weekly publications, magazines, news broadcasting sites, etc. By seeing the closeness of specific terms often in many documents, it becomes clear that they have a certain term relationship. Those terms are then extracted in process 1102, and matched against table 910 described earlier in FIG. 9. If they are found in the table, a new entry may be entered in the table 920 as related, and the Rx 925 column may be initially entered according to a default, or by interaction with a human (i.e., request for clarification sent to an operator, not shown, and further discussed below).

In many cases, a term may have an extraneous additional adjective or adverb attached to it; for example, “the color red” as in a red Mustang. However, the word red in other cases may be part of the term, such as a “red herring.” As a result, the potentially extraneous words in terms, such as adjectives, prepositions, adverbs, etc., should not be automatically stripped, but instead should be marked at potentially extraneous, and may therefore be ignored in matches or not. If no perfect match can be found, then a match with ignoring some of those extraneous words will be used as the next closest thing.

In process 1103, the match is analyzed, taking into account the possible presence of extraneous words, and then in process 1104 it is presented for review by a human operator. This review could be accomplished in any of several different ways. One possible method could be for a linguist to review those new term relationships, analyze them, and then store them in database 920 (Rx value for 925 column). Another way could be that the new relationships could be presented to a number of users in the form of a game, and once at least 20 or 50 or 100 users have responded, the pairings could be analyzed according to the “20/80 rule” (the 20 percent furthest off are discarded, the 80 percent clustered together are retained). The average weight then calculated using the remaining 80 percent could be used to determine the initial position of the new term, with the position then further fine-tuned by subsequent actual usage and also by the incidence rate of this relationship as later found in documents parsed on the Web.

According to the results of process 1104, initial relationship parameters for database 920 (Rx value for 925 column) are created in process 1105.

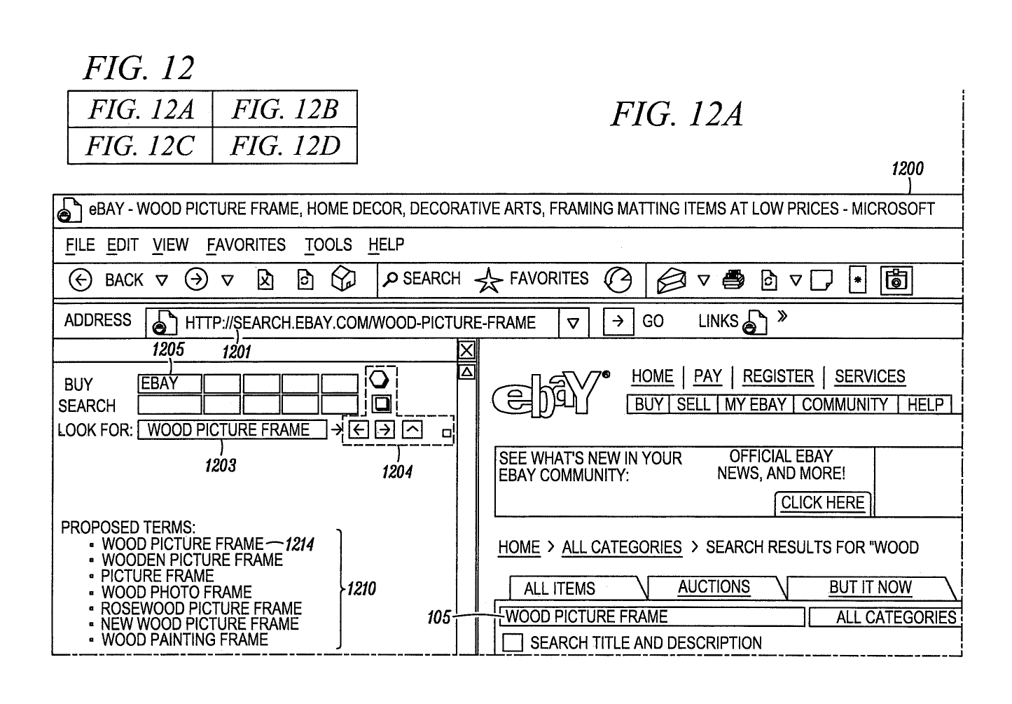

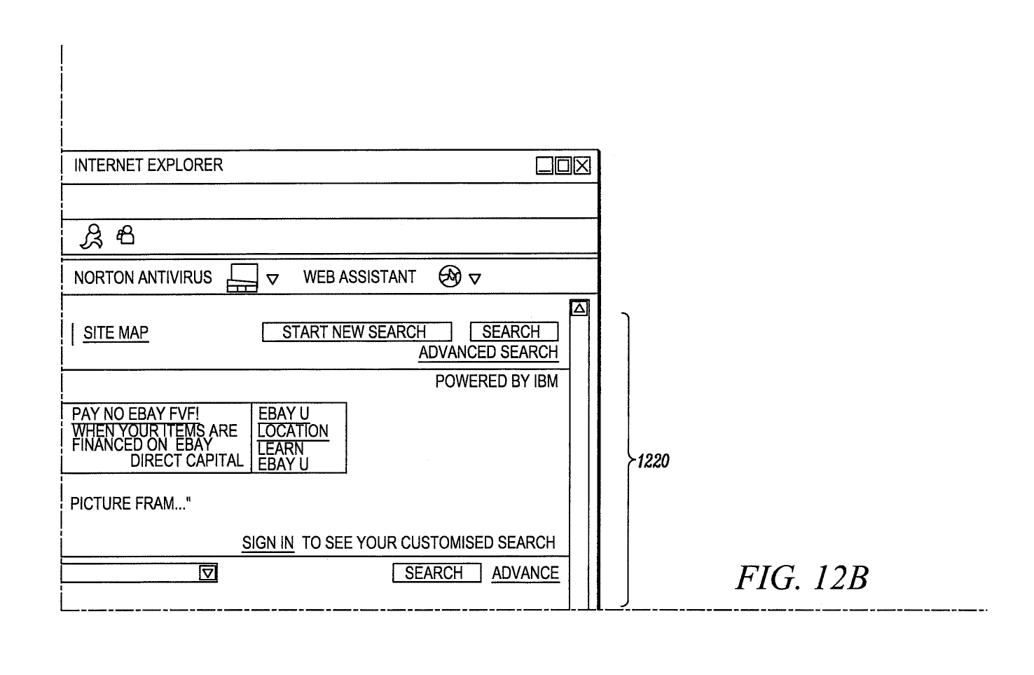

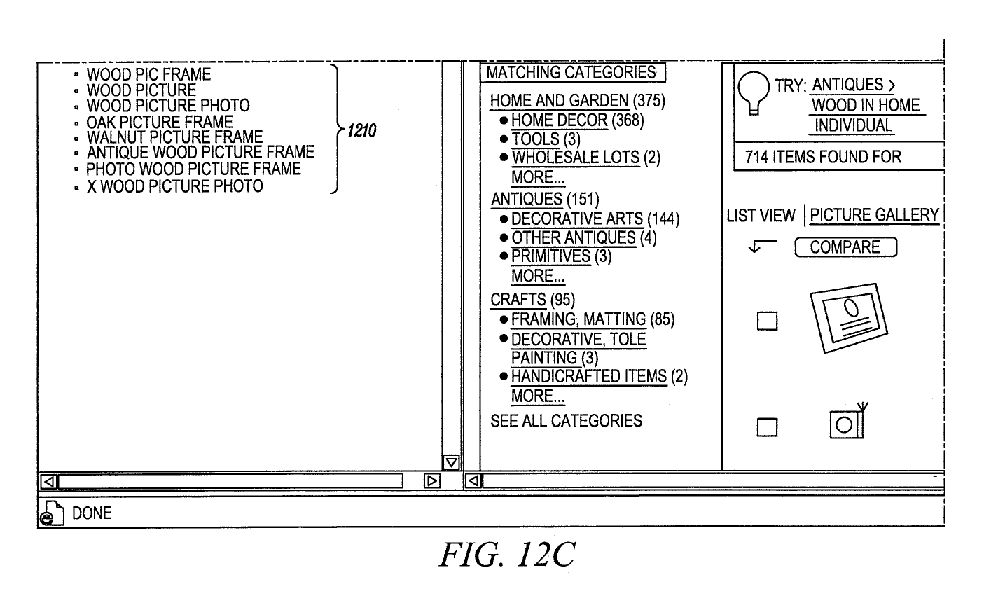

FIGS. 12A-D show sample screen 1200 of a search according to the novel art of this disclosure. In field 1202 several shopping search engines are shown. Out of the selection of 10 possible search engines, field 1205 shows that eBay has been selected. Also, in browser window 1200 a standard URL 1201 appears, which is the normal eBay URL (in this example, eBay is used as the shopping engine) that would show if the user entered the search term directly into the eBay search engine. The search term is shown in field 1203, along with a list of proposed related terms 1210, out of which search term 1211 is highlighted, to indicate the selected term. The relationship is determined using the same approach as previously discussed in the co-pending applications, and as is further enhanced according to the novel art disclosed below. Additionally, several buttons 1204 are shown, some to for navigation, and some to select various skins, such as a hex pattern, or list mode skin as described in previous co-pending applications known to the inventors. It is clear that additional skins may be added, some targeted to specific purposes. For example a clothes and fabric shopping skin may show pattern of fabrics next to the term describing them, or a home decoration skin may show color samples, window dressings, etc. The section of the window 1220, the browsing window, shows the exemplary eBay result, and the selected term (in some cases with or, as shown, without category) in eBay search fields 1221a, b that has been generated by the application, although it appears as it would if it had been entered by the user. The content of the eBay search fields has the same or corresponding value as field 1211, the selected proposed search term.

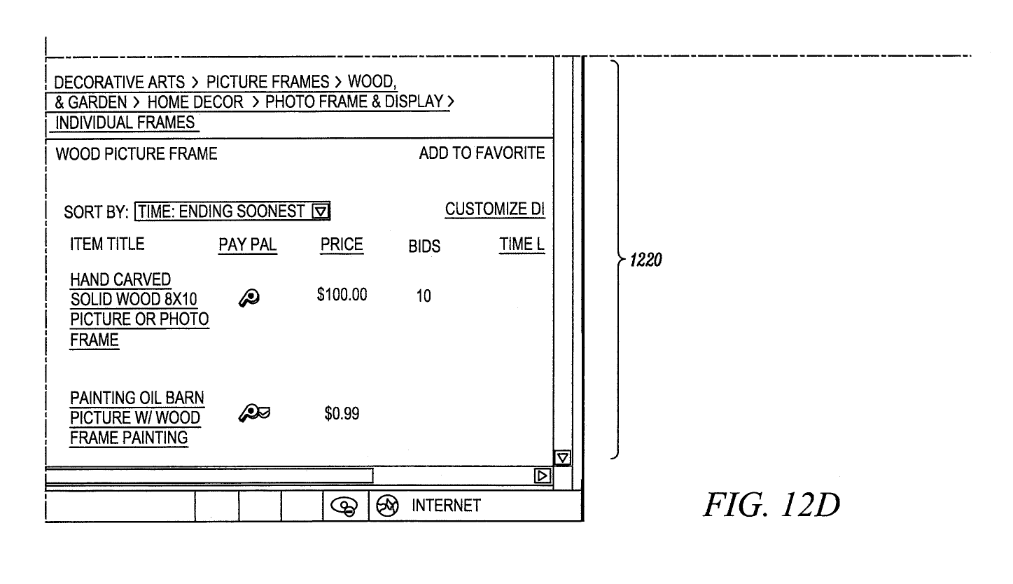

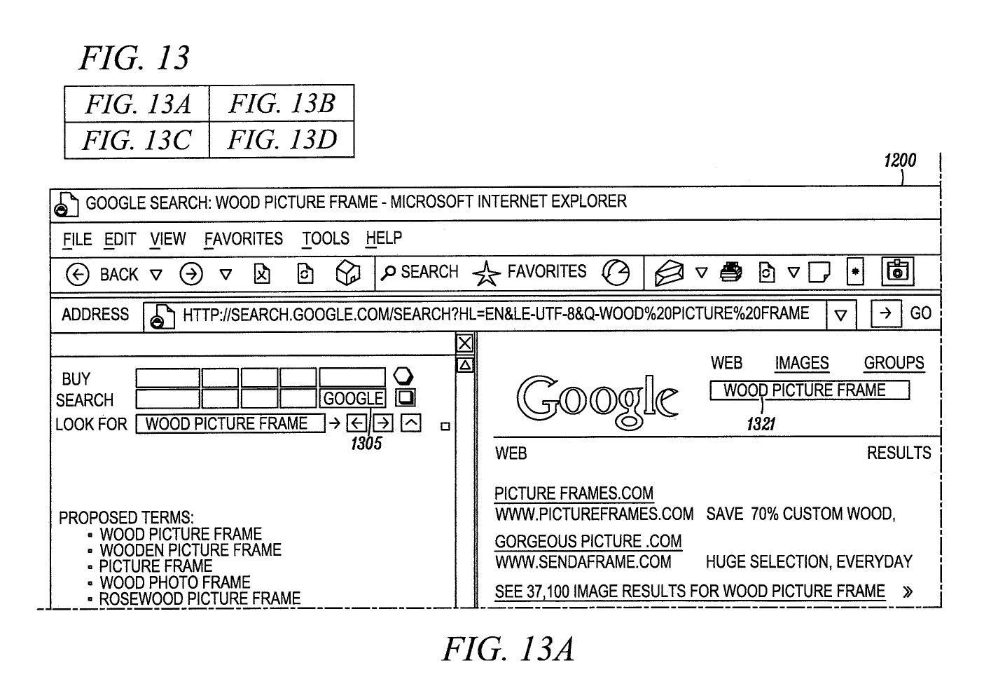

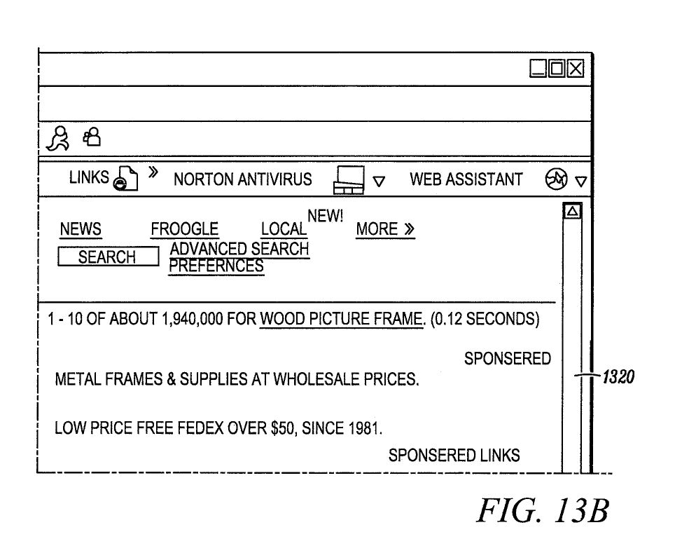

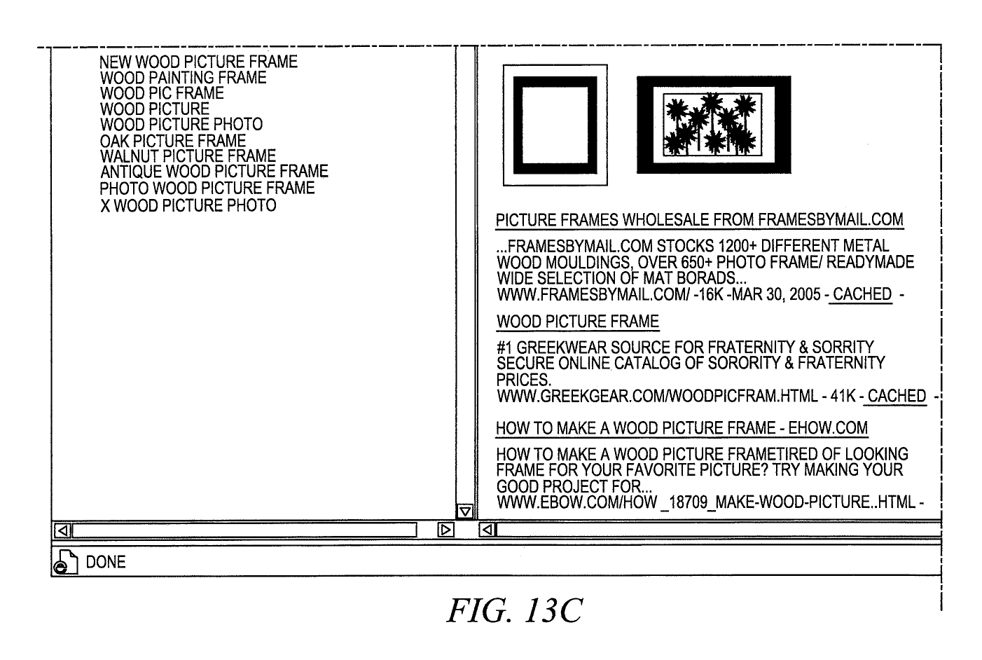

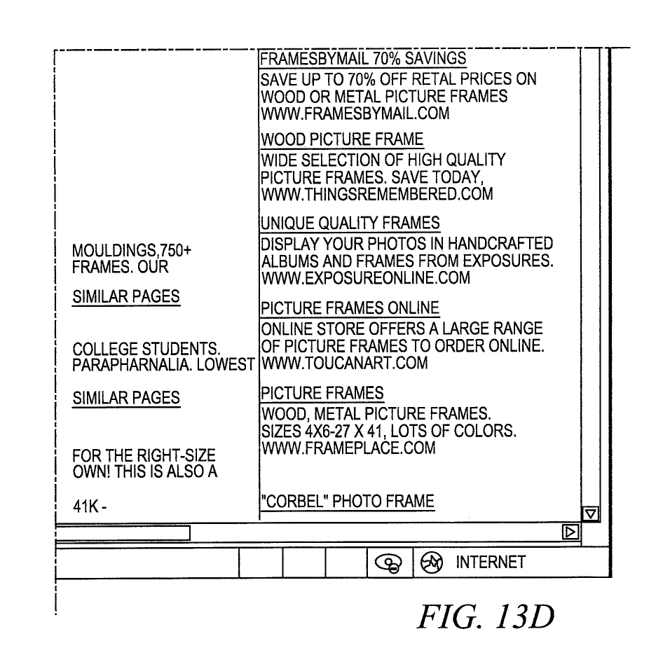

FIGS. 13A-D show the same input, the same search terms and proposed terms, but because the user has moused over the field representing the desired search engine, in this example Google, field 1305 has been selected, which now shows the Google search engine on the browsing window. The URL field 1301 shows the standard Google URL, and in the Google window 1320 the search term appears in Google field 21, as it would if the user had entered it directly into Google on their Web site. However, to get from the interface shown in FIG. 1 to the interface shown in FIGS. 13A-D, all the user had to do was move his mouse over the selector field in section 102 that is 1305, and once it was highlighted, the Google search was immediately launched.

Additionally, in some cases, a personalized bar (not shown) may be also available. It would allow a user to select a list of engines, both for search and or shopping as well as catalogs, from a pool available, or user selectable at will, for example using SOAP (Simple Object Access Protocol) interface to an unknown Website, and use the mouse over to select which ones to show and feed the input. In some cases, this maybe offered as a separate tool, without the term engine.

Following is a sample description used to create programmer's code for the system and method that is used to extract the relationship information from a given database set of item descriptions. The description adheres to the previously discussed tri-table database system, using a word table, a term table, and a relationship table, wherein the relationships are assigned specific values using the polar coordinates that were described in earlier co-pending applications. Processes 1-4 describe building the first two tables, processes 5-9 are use to create the polar coordinates in this example. In addition, process 10 is used during a query, but may in some cases be partially or completely built into the data for faster lookup. As mentioned in the co-pending applications, other data sets may be used, or dimensions beyond two (2) may be used for refined relationships.

Processes 1-10:

1. A word dictionary is build by extracting all unique words from, for example, a searched web site items database. The algorithm of splitting items into words can be described separately.
2. All words in the dictionary that were used in items more than 20 times are selected. These words are 1-grams.
3. All couples of words in the dictionary that were both used in the same item more than 20 times are selected. These words are 2-grams.
4. Similarly, 3- and 4-grams are built.
5. 5. Relationships are created using the following approaches:
6. 6. For situations with a collocation factor of less than 5%:
7. same words in multi order n-grams
   7.1 n-gram_{A} is broader than (n+1)-gram_{B}-->set angle to 90 (A to B), 270 (B to A), or drift angle to that if value already set, use 361 for not set
   7.2 (n−1) gramc is broader than n-gram_{A}-->set angle to 90 (C to A), 270 (A to C), or drift angle to that drift according to this relationship:
   7.3 3 gram→67% weight on new. We also take into consideration which word (in order) is missing in the 3-gram.
      7.3.1 AB-ABC assigned weight=663
      7.3.2 AB-ADB assigned weight=664
      7.3.3 AB-EAB assigned weight=665
      7.3.3a. (weight=666−sequentional number of word which makes two n-gram different)
   7.4 4 gram→75% weight on new weight=750−sequentional number of word which makes two ngram different, etc.
   7.5 Example: antique cherry wood table and cherry wood table have weight=749
8. Relationships between same order n-grams
   8a n-gram_{A} shares n−1 words with n-gram_{B}-->look up words in thesaurus, see if either direction shows synonymy or antonymy
   8b Angle:
      The third-party thesaurus (from Word Web Pro) gives for each word suggestions grouped in 13 categories: synonyms, antonyms, broader, part of, . . . We combine synonyms and antonyms into group #1 (which will use angle=180 degree) and all other into group #2 (which will use angle=0 degree).
   8c Weight:
      If word C is related to word X, than weight of relationship between n-gram ABCD and AXBD is calculated as 1000−32, where:
      1000—is constant.
      32—two digit number, where first digit (3) is position of the changed word (C) in the first n-gram, and second digit (2) is position of the changed word (X) in the second n-gram Weight of relationship between AXBD and ABCD=1000−23 (if words X and C are related in this direction).
9. If synonym in both direction, relation 1-3 (strong), if one direction, 2-5 (position in list relates to range, ie., 3^{rd} item out of 10 (lower one) in both directions would be R=3/10*2+1=1.6; or 6 out of 9 in one direction would be R=6/9*3+2=4)
   drift angle to 180, weight 102%-2%*R
   Examples: Starbucks cup and Starbucks mug, synonym, one direction. Weight=1000−22=978, angle=180
   antique cherry wood table and old cherry wood table, synonym, two direction, Weight=1000−11=989, angle=180
10. User Query Processing
   1. There are four output sectors. Each sector has 4 or 5 vacant slots. These sectors correspond to angles between n-grams.
   2. User query is preprocessed by splitting into individual words. Words are normalized.
   3. If user query match to a known n-gram, that from all related n-grams the most related are selected for each sector. If two n-grams have equal weight, than the one which has more occurrences in eBay DB has precedence.
   4. If user query does not match any known n-gram. The thesaurus and spellchecker are used. We try to substitute a word(s) in input query with a related or corrected suggested words and check the modified request against known n-grams.

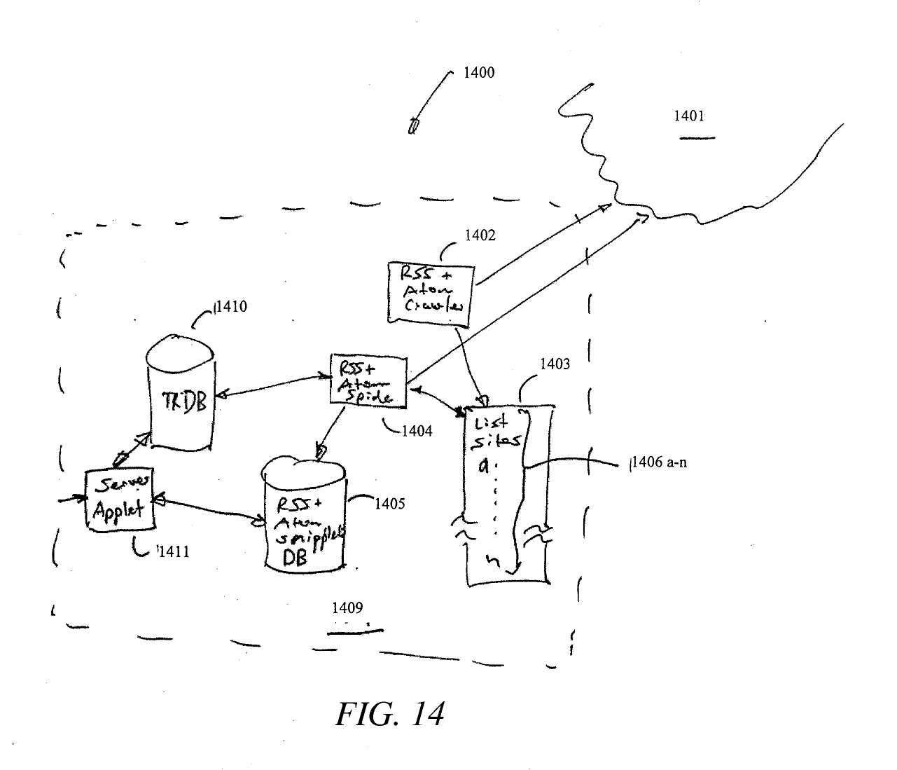

FIG. 14 shows a simplified overview of an exemplary preferred embodiment of the real-time content association system 1400. This example is a very advantageous use for a system, as shown in this example, because it does not require metadata to properly index information in near real-time. A crawler 1402, for example, a real simple syndication (RSS—as this is a relatively new term, see also http://en.wikipedia.org/wiki/RSS (protocol) for additional and alternate definitions) and/or Atom feed crawler (it could also include other, similar data feed mechanisms) would crawl the Internet 1401 to continuously update a list of available RSS and Atom feed sites. This list of sites would be kept in list 1403, which contains URLs for many sites or their respective feeds 1406 a-n. A typical site may often have multiple feeds. Then RSS and Atom spider 1404 would spider those web sites at certain intervals and update RSS and Atom snipplet database (RASDB) 1405, which could contain, for example, five days' worth of RSS and Atom snipplets for each of the sites indexed in list 1403. It is clear that additional filters could be used; for example, certain sites may be blocked for unwanted content, or filtering of certain terms might be used to block certain types of content (not shown). Also, as discussed further below, during the downloading of those snipplets, they are processed against term relationship database 1410 in terms of keywords and terms and indexed by terms. Also, the lists that are started could be lists that are manually generated, or they could be lists that are generated using a search engine of any of various types that are well known in the art (not shown). When server applet 1411 gets a request for a term, it can also send out a request to the RASDB 1405 and get, along with the related terms, a set of suitable matching related RSS and Atom snipplets, which then may be presented as additional content to the client making an n-gram request.

Both RSS and Atom feeds use an XML-type publishing mechanism, allowing a headline or summary to be syndicated for publishing on other sites and or desktop engines, such as RSS and Atom readers. RSS is currently mainly text only, Atom allows for richer media. The XML cliplet usually also contains a link to the syndicating website's full article. This short characterization is only for better understanding here, and as it is a very dynamic field, by the time of publication of this application, already some (or many) details will have changed. The underlying principle will, however, likely remain.

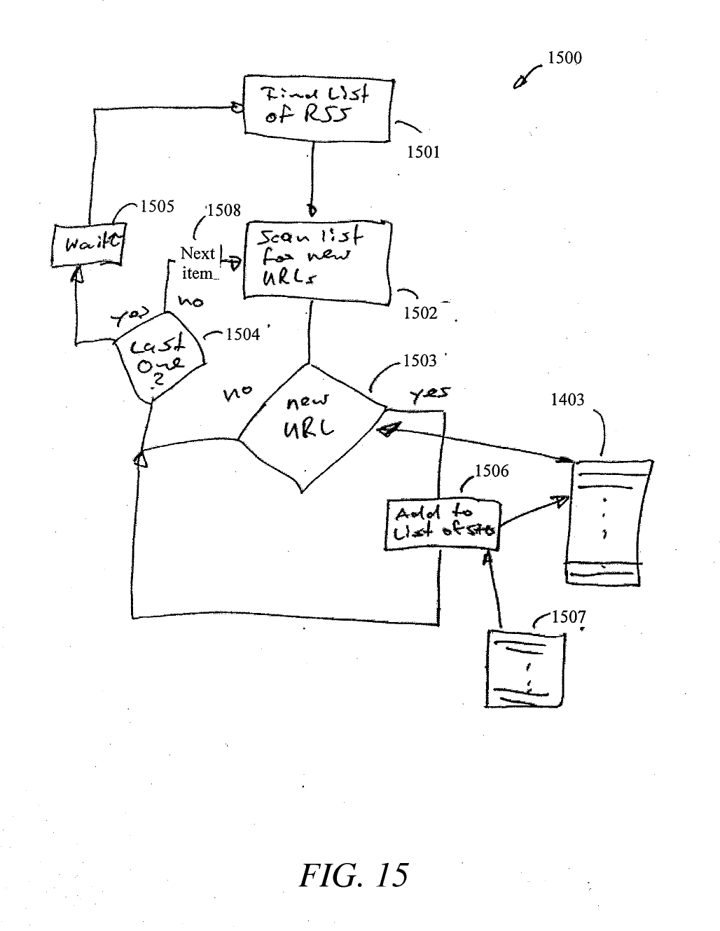

FIG. 15 shows an exemplary process flow 1500 of generating web site lists 1403. In step 1501a list of RSS feeds is found. (Note that the process 1500 applies also to Atom feeds, or other, similar feeds, but for reasons of simplicity and clarity, only RSS feeds are shown in this diagram.) In step 1502 the list is scanned for new URLs. At step 1503 the process branches. If a new URL is found (yes), the process moves to step 1506, where it is added to list 1403, provided it is not blacklisted in a separate list 1507. Then the process moves to step 1504. If, at step 1503, no new URL is found (no), the process also moves to step 1504. At step 1504 the process again branches. If, at step 1504, it is determined that this is not the end of the list (no), the process returns via step 1508, where the next item is selected, to step 1502, to scan the next item on the list. If it is determined that this is the end of the list (yes), the process moves to step 1505, where a certain time-out period is observed before returning again to recommence at step 1501. This time-out period reduces strain on resources that provide such lists. As mentioned earlier, these lists may be obtained from other sites or, for example, by spidering searching engines, or in other cases, they may be generated manually.

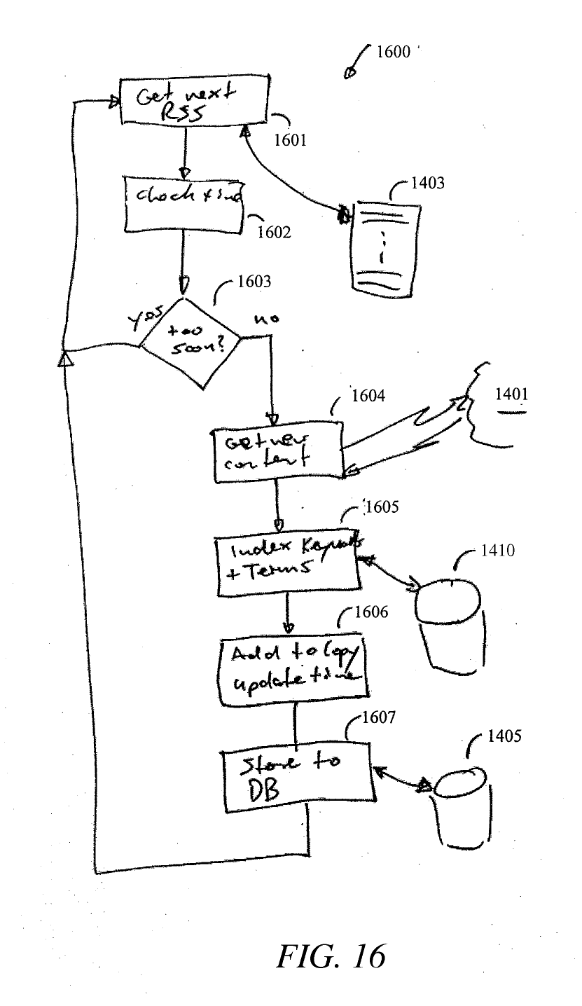

FIG. 16 shows a simplified process flow 1600 of the operation of RSS and Atom spider 1404. In step 1601, the next site URL is obtained from list 1403, and in step 1602 the time is checked. (Note, again, that the process 1600 applies also to Atom feeds, but for reasons of simplicity and clarity, only RSS feeds are shown in this diagram.) Then at step 1603 the process branches. If the pre-set time-out period has not elapsed; that is, if it is too soon to begin to spider this particular web site again after the last spidering (yes), the process loops back to step 1601. If it is too soon to begin again for any site, the URL may be reviewed again in the next loop, at which point the time to hold off may have elapsed. If, however, the pre-set time-out period has elapsed; that is, if it is not too soon (no), the process moves to step 1604, where new content is downloaded over the Internet 101 from the URL obtained in step 1601. Then in step 1605, the keywords and terms are indexed, using database 1410 (or a copy thereof). In step 1606 the content is processed and the time period until the next spidering event is calculated. In step 1607, the results from step 1606 are then stored in RASDB 1405, and the process loops back to step 1601.

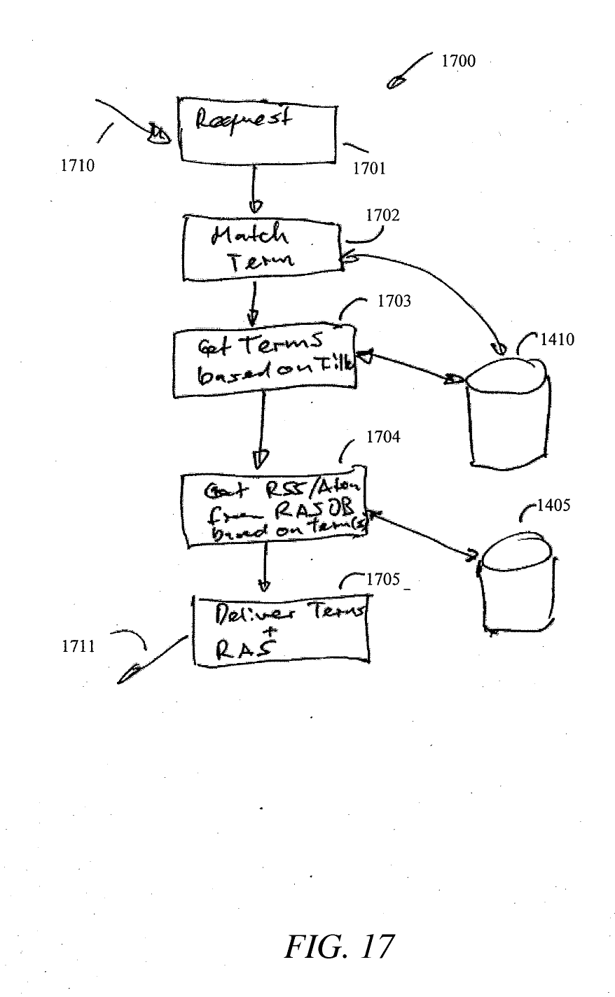

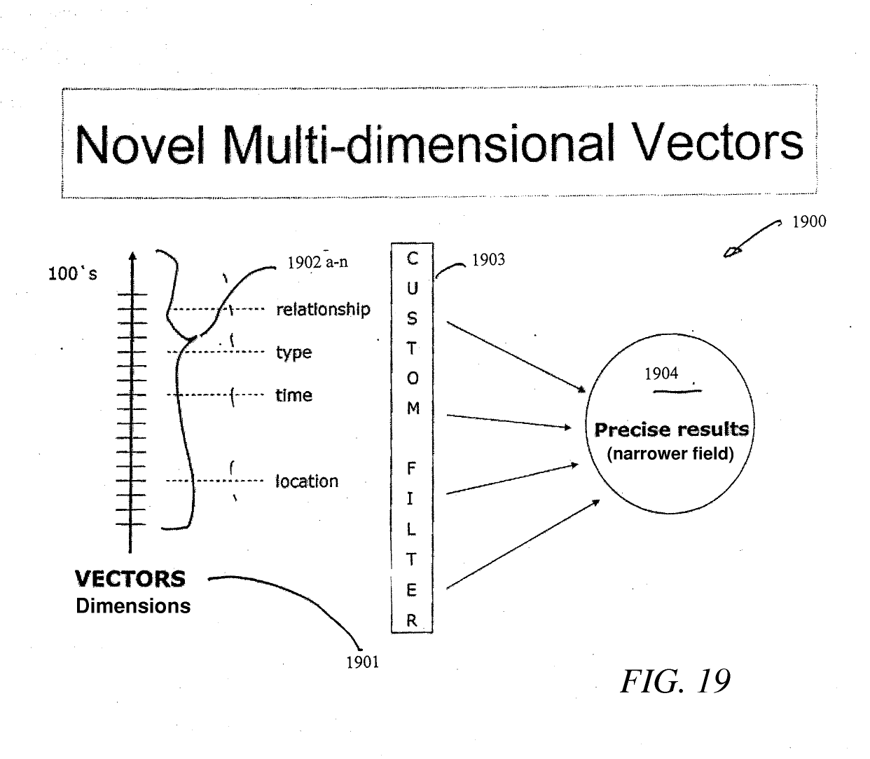

FIG. 17 shows an exemplary process flow 1700 of the operation of server applet 1411. In step 1701, a request 1710 for a keyword comes in from a client machine, as discussed earlier. In step 1702, the applet produces a term match against the requested term from TRDB 1410 or a copy thereof, and in step 1703 the terms, based on the filter as discussed in FIG. 19, below, are filtered and pulled out of database 1410 (or the copy). In step 1704 the matching RSS and or Atom content from RASDB 1405 is loaded and in step 1705 the terms and the RAS content are delivered back via reply 1711 to the client who made the request.

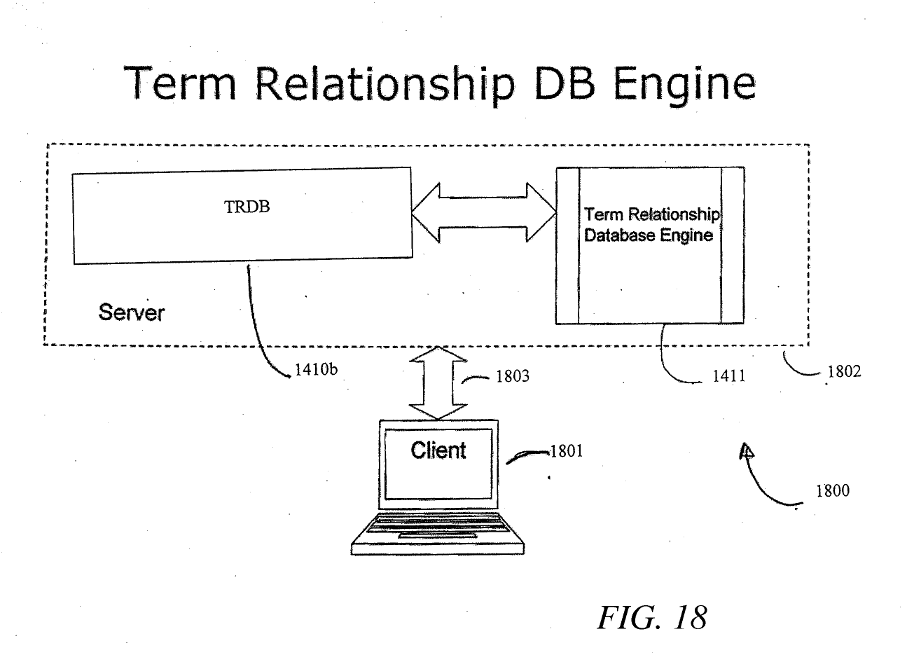

FIG. 18 shows a simple overview of a TRDB server system 1800. This system 1800 has a typical server 1802 that could be used to make term memory table database (MTD) 110b (essentially a token performance tuned, compressed version of TRDB 1410) available to client machine 1801 through a connection 1803, which would typically be the Internet. In some cases, however, this connection 1803 could be intramachine (in the case of a desktop term relationship database), intranet (in the case of a corporate term relationship database), or any other useful type of connection or coupling. Client machine 1801 accesses the server 1802 by sending a request to the TRDB engine 1411, which then looks up the MTD 1410b, retrieves the related terms from it or therewith (in case of additional accesses to TRDB 1410 and or thesauri, as discussed earlier), and delivers them back to the client.

FIG. 19 shows a schematic overview of an aspect 1900 of the functional use of the vectors within term relationship database 1410 (and/or compressed version TRDB MTD 110b). This TRDB could be the memory table 1410b discussed earlier, or it could be an ODBC type database (e.g., 1410, uncompressed), as discussed earlier, or it could be any combination or similar database or derivative thereof. Although the current example shown and discussed above has approximately 10 to 20 dimensions, there is no reason why vectors such as vectors 1901 couldn't have hundreds of dimensions 1902 a-n. They could include, in addition to the relationship dimensions that were discussed earlier, other aspect that were also discussed earlier, such as “type”, i.e., field of use, or time, i.e., a point in time, the publishing time, the time when something is due, a time range, such as a festival ongoing and location, which could be an accurate pin-point location, or a general location, such as a city, a village, a region, county, a country or state, etc. Additional things could be terminologies and association to specific fields of use, related to specific sets of TRDBs, as many can be present at the same time, as described earlier. For example, a specific vector may be associated with multiple fields of use at the same time, or just one, or no specific field. Generally speaking, the more words are involved in an n-gram's vector, the more specific to a field it is likely to be, whether identified in the type or not.

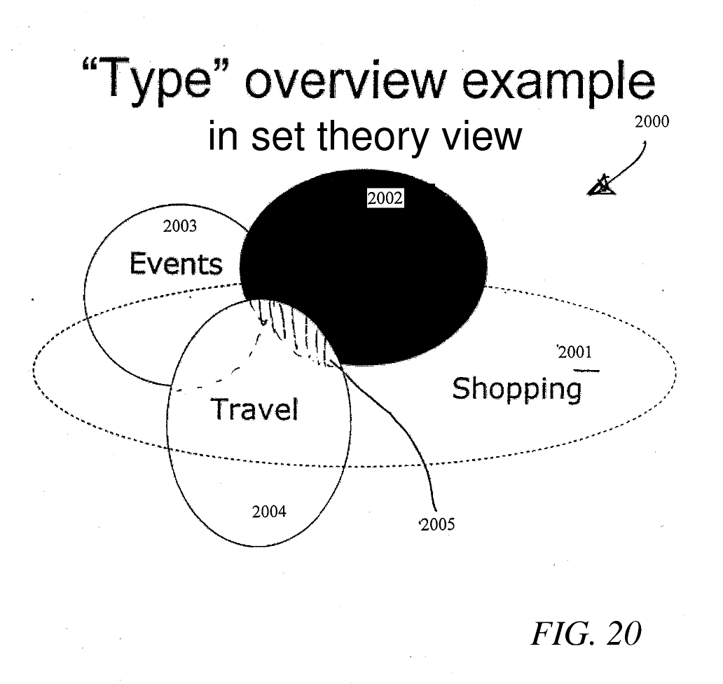

FIG. 20 shows an exemplary use of the type dimension discussed earlier in FIG. 19, shown as a set-theory view 2000. For example, a type that describes various different items or things or events based on their affinity shopping 2001, medical-related 2002, events 2003, and travel-related 2004. The intersection set 2005 would show things that are in the range of medical and travel, within shopping, and have some overlay with events. There could be, for example, items that are suitable for travel and have medical functions, such as special socks, or special pillows to avoid neck or back pain, etc. The event intersection could be events where such articles are introduced or sold, etc. It is clear that the intersection set 2005 is only exemplary and very simplistic and could be further expanded in a dramatic way, especially when combining multidimensional intersection sets, but those are hard to illustrate on paper.

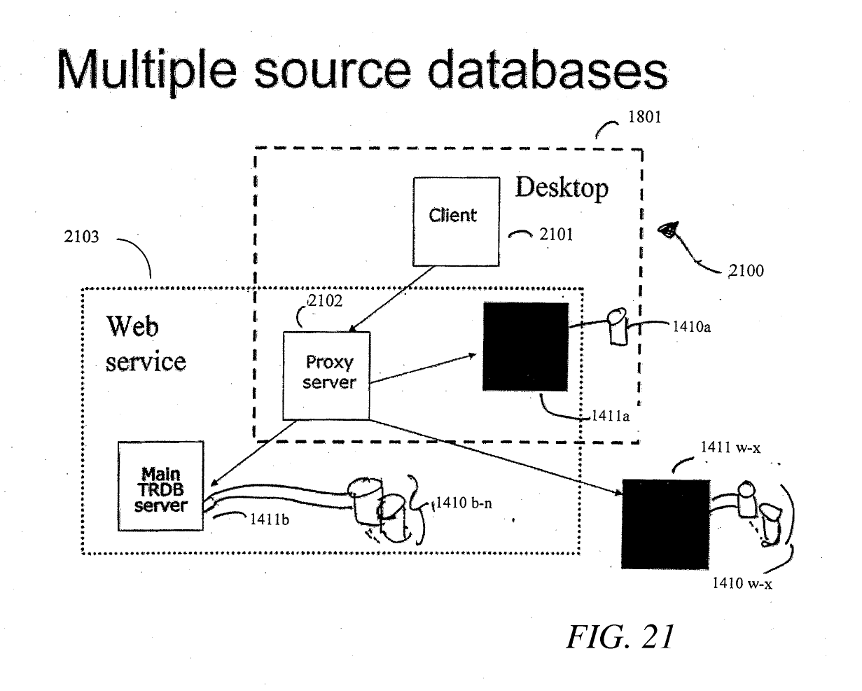

FIG. 21 shows more detail about using multiple local and remote database, as discussed earlier. Data map 2100 shows an example of a multi TRDB architecture, using a proxy to determine which TRDB to use. Client machine 501 contains a desktop client 2101. Typically such a client could be a browser plug-in or some Ajax-type application running in the browser, or some regular Java script. It may also have, on the desktop, a proxy server 2102, but in some cases the proxy server may reside in a web server, as it is shown also as part of web service 2103 (made of one or more servers). Technically, it may not be a web service, as it may be entirely inside a private network and not part of the web, but shall here be commonly referred to as web service nonetheless, either locally or remotely. Desktop server 1411a has its own database 1410a for desktop content—that's all content residing in the user's machine 1801. The proxy server then decides how to redirect requests, or it could also multicast requests to all servers at the same time. Main term relationship database server 1411b would be typically a web service and could contain multiple databases 1410 b-n, or in some cases the request may be sent, for example, to an intranet, or VPN, or some other type of additional TRDB server 1411 w-x with databases 1410 w-x.

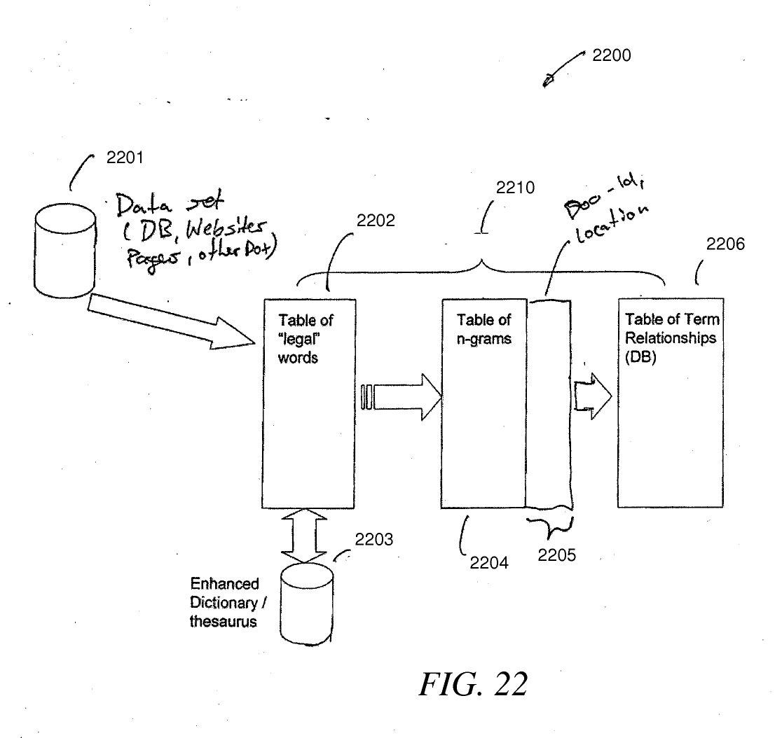

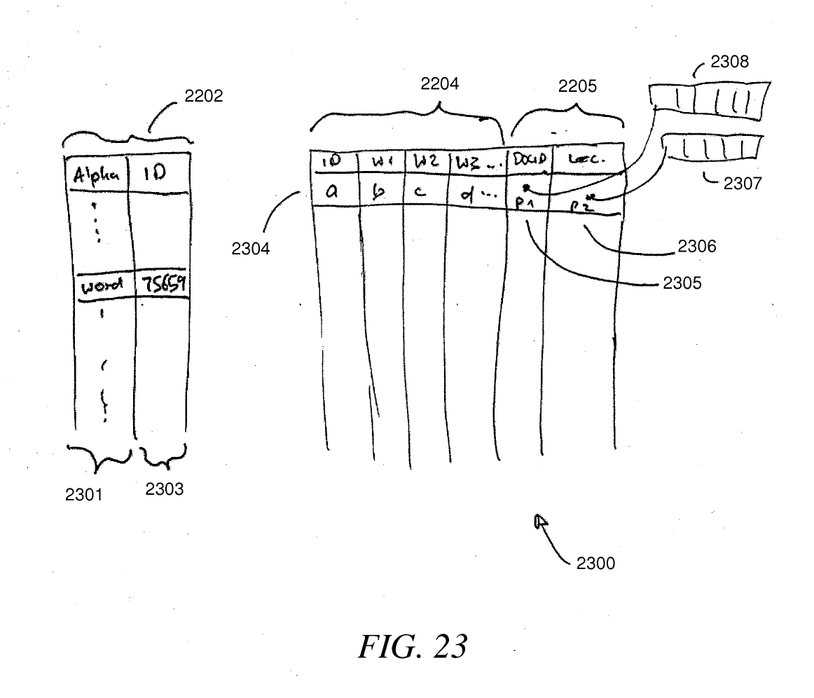

FIG. 22 shows an enhanced overview 2200 of the software system for term (n-gram) and term relationship extraction/generation, as previously discussed above, in the description of FIG. 2. A data set 2201 could be one or multiple databases, one or multiple web sites, a collection of pages or other suitable documents. For example, the above described system 2210 is then running a software instance 155, for example, first to extract a table of “legal” words 220, by use of the enhanced dictionary/thesaurus 2203, which in some cases could be a very field-specific type of dictionary, or in other cases could be a broad and all-inclusive dictionary of the search language. Then a table of n-grams 2204 is extracted, using the algorithms further discussed above in the descriptions of FIGS. 9 thru 13. Novel in this example of the present invention is the addition of enhancement 2205 to the n-gram table, which includes a document ID and a location in the document, which is described in greater detail below in the description of FIG. 23. The process then continues with the generation of a table (database) of term relationships 2206.

FIG. 23 shows an exemplary set of details 2300 of table 2202. In principal there are two columns, with one column 2301 containing the alpha value, that is, the word itself, and the other column 2303 containing the corresponding word ID, which is a numeric representational token for that word. Also shown is a section of the enhanced n-gram table 7-104 with the n-gram ID shown as a in row 2304, followed by words 1-n shown as b, c, d . . . n. Typically, the table would be limited to perhaps 8 or 16 words, but the underlying technology does not require any such limit. Novel enhanced table 7-105 has, in this example, two pointers, one for the document ID and one for the location ID. These pointers don't point to the actual documents or locations, but rather to data lists 2308 (pointer 2305) and 2307 (pointer 2306), which contain a number of documents and locations in those documents.

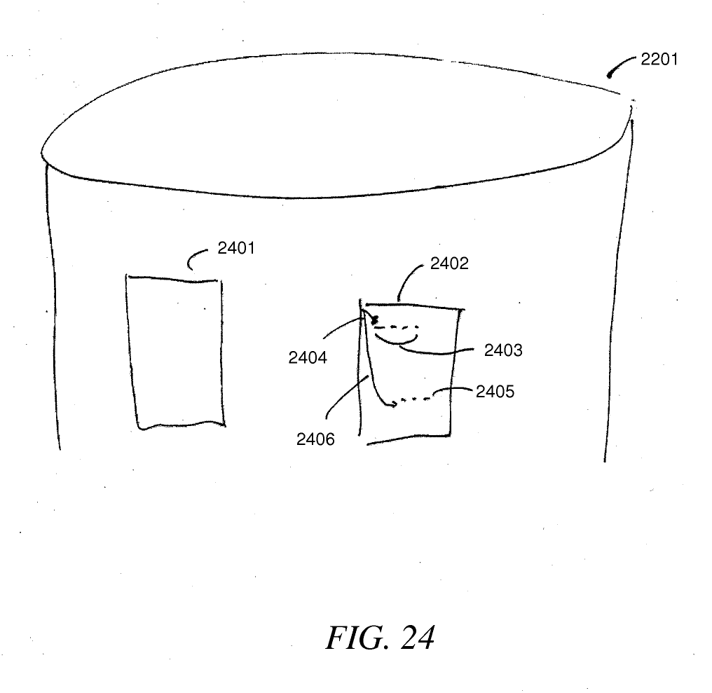

FIG. 24 shows the data set 2201. In it are shown two exemplary documents, 2401 and 2402. In document 2402, a match is found for n-gram 2403. In this example, the location inside the document is shown as the vector 2404. This location could be defined as, for example, line and character position, or number of characters, or number of words, or any other suitable measure to show the location of words in the document. Also, a second n-gram 2405 is shown with its location inside the document.

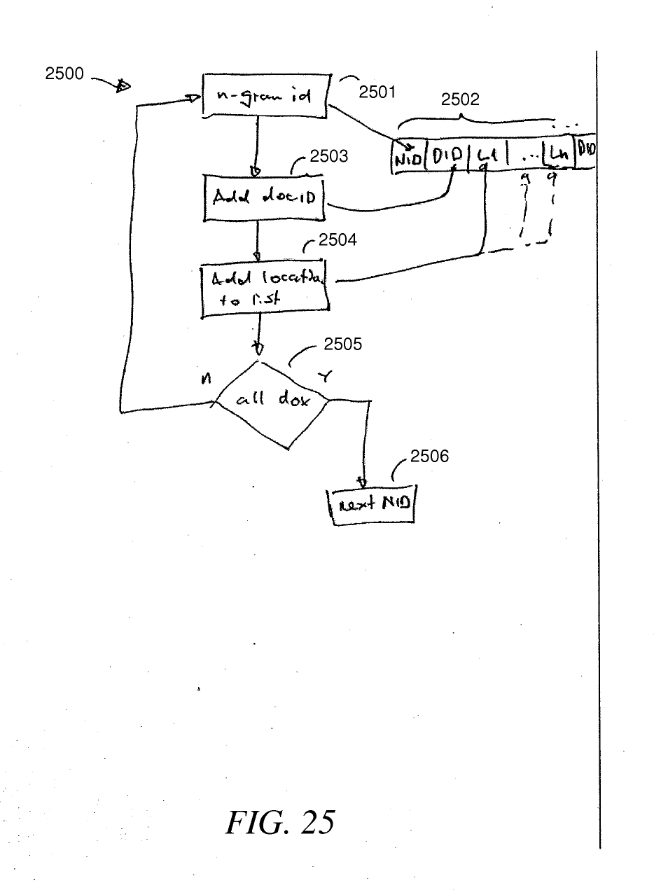

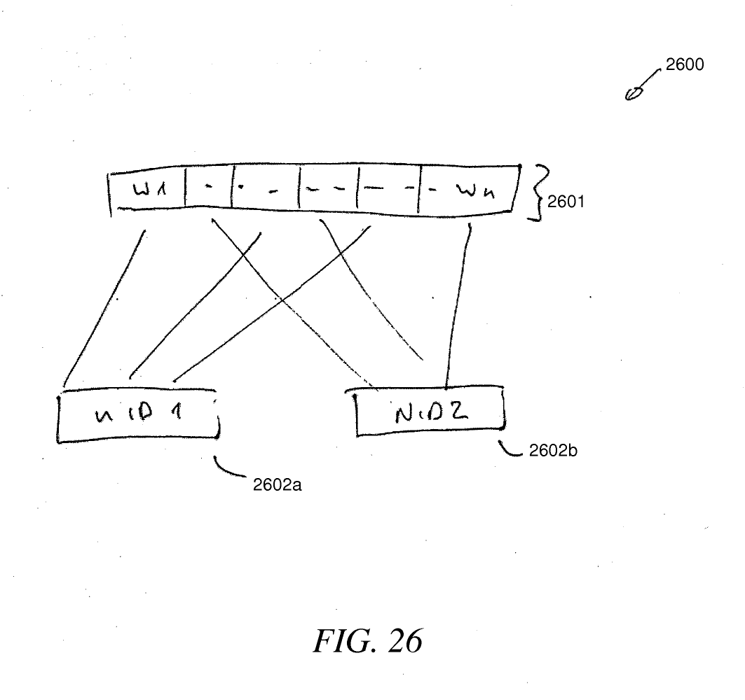

FIG. 25 shows an exemplary process 2500 for implementation of the system according to one embodiment of the present invention. After an n-gram has been identified, in step 2501 its ID is added to a list 2502, which list combines data for both the previously discussed lists 2307 and 2308. In step 2503 the document ID is added into the list, and in step 2504, the locations can be added. There are advantages in having a combined list, rather than separate lists; but there are also advantages, which are discussed below in the description of FIG. 26, in having separate lists. In step 2505, the system checks to determine whether all documents have been indexed. If not all documents have been indexed, the process loops back to step 2501; but if all the documents have been indexed, the process moves on to the next n-gram ID in step 2506.

FIG. 26 shows the approach 2600 of the current invention for a search. In this example, the search term is term 2601. It contains n words W1-Wn. Because no matching n-gram is found for term 2601, it is split into a subset of the most suitable n-grams, which, in this example, are n-gram ID1 2602a and n-gram ID2 2602b. The split operation could have any of various approaches. In some cases, for example, a balanced approach is used, wherein the system attempts to make the two n-grams very similar in size. In other cases, the system first searches for the largest n-gram, with as many words as possible, that can fit into search term 2601. In other cases, a more balanced approach maybe taken, and two equal sized n-grams maybe chosen. In yet other cases, the user might be able to indicate a break point, for example by using a special character, etc. In yet other cases, the frequency of used n-grams maybe used to determine one or more breakpoints, hence improving chances to find cached tables for matching, etc. Then the remaining words are then put into a second n-gram. This latter approach may be advantageous because an n-gram with a large number of words occurs less often, and therefore the lists to be searched are shorter. To complete the search, the tables with the document IDs are cross-linked for each of the n-grams, and only documents that have both appearances are identified as “hits.” Furthermore, it is possible to have more than two n-grams. For example, for very complicated searches, there could be three or four n-grams. Also, because the location ID is given, there could be rules governing how tight or loose a search should be. The tightness or looseness would designate a distance in characters, word, lines, etc., inside a document.

The processes described above as example in pseudo code instructions can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc. In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

It is clear that many modifications and variations of this embodiment may be made by one skilled in the art without departing from the spirit of the novel art of this disclosure.

What is claimed is:

1. A method comprising:
receiving a search request, the search request comprising of one or more search terms limited to one or more selected dimensions of a multi-dimensional term relationship database (MDTRD);
using the one or more search terms to search the database within the one or more selected dimensions of the database, to identify one or more additional search terms related to the search terms of the search request; and
performing at least one of, presenting the additional search terms to be selected from to perform the search request, or performing the search requests using one or more of the additional search and presenting the results of the search request.

2. The method of claim 1, further comprising receiving the one or more selected dimensions pre-selected based on a context of the search request being submitted.

3. The method of claim 1, further comprising receiving the one or more selected dimensions explicitly identified with the search terms.

4. The method of claim 1, wherein the dimensions of the MDTRD include one or more of time, type, and geography.

5. The method of claim 4, wherein the dimension of type includes at least one of event and person.

6. The method of claim 1, further comprising modifying dimensions of the MDTRB based on categories encountered during a learning of term relationships.

7. A system comprising:
a unit to receive a search request, the search request comprising of one or more search terms limited to one or more selected dimensions of a multi-dimensional term relationship database (MDTRD);
a unit to use the one or more search terms to search the database within the one or more selected dimensions of the database, to identify one or more additional search terms related to the search terms of the search request; and
a unit to perform at least one of, presenting the additional search terms to be selected from to perform the search request, or performing the search requests using one or more of the additional search and presenting the results of the search request.

8. The system of claim 7, further comprising a unit to receive the one or more selected dimensions pre-selected based on a context of the search request being submitted.

9. The system of claim 7, further comprising a unit to receive the one or more selected dimensions explicitly identified with the search terms.

10. The system of claim 7, wherein the dimensions of the MDTRD include one or more of time, type, and geography.

11. The system of claim 10, wherein the dimension of type includes at least one of event and person.

12. The system of claim 7, wherein the MDTRB includes a unit to modify the dimensions of the MDTRB based on categories encountered during a learning of term relationships.

13. A machine-readable medium having stored thereon a set of instructions, which when executed, perform a method comprising:
receiving a search request, the search request comprising of one or more search terms limited to one or more selected dimensions of a multi-dimensional term relationship database (MDTRD);
using the one or more search terms to search the database within the one or more selected dimensions of the database, to identify one or more additional search terms related to the search terms of the search request; and
performing at least one of, presenting the additional search terms to be selected from to perform the search request, or performing the search requests using one or more of the additional search and presenting the results of the search request.

14. The machine-readable medium of claim 13, further comprising receiving the one or more selected dimensions pre-selected based on a context of the search request being submitted.

15. The machine-readable medium of claim 13, further comprising receiving the one or more selected dimensions explicitly identified with the search terms.

16. The machine-readable medium of claim 13, wherein the dimensions of the MDTRD include one or more of time, type, and geography.

17. The machine-readable medium of claim 16, wherein the dimension of type includes at least one of event and person.

18. The machine-readable medium of claim 13, further comprising modifying dimensions of the MDTRB based on categories encountered during a learning of term relationships.
